(19) United States
(12) Patent Application Publication
(10) Pub. No.: US 2009/0102807 A1
(43) Pub. Date: Apr. 23, 2009

(54) BOOK-SHAPED DISPLAY APPARATUS AND METHOD OF EDITING VIDEO USING BOOK-SHAPED DISPLAY APPARATUS

(75) Inventors: Kotaro KASHIWA, Kanagawa (JP); Mitsutoshi Shinkai, Kanagawa (JP); Junzo Tokunaka, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/206,208

(22) Filed: Sep. 8, 2008

(30) Foreign Application Priority Data
Oct. 18, 2007 (JP) 2007-271348

(51) Int. Cl. G06F 3/041; H04N 5/93

(52) U.S. Cl. 345/173; 386/52

(57) ABSTRACT

Disclosed herein is a book-shaped display apparatus including: a cover portion; sheet portions each formed by a flexible paper-like display device; a spine portion that binds the cover portion and the sheet portions, so that the book-shaped display apparatus has a book-like structure with the sheet portions constituting pages. The apparatus further includes: an external interface section that receives, from an external device, pieces of frame data that constitute a video; a storage section that stores the pieces of frame data; a sheet display control section that drives each sheet portion to present a display; and a control section that generates display image data for each sheet portion using the frame data stored in the storage section, supplies the generated display image data to the sheet display control section, and controls the sheet display control section to present a still image display on each sheet portion.

### CROSS REFERENCES TO RELATED APPLICATIONS

The present invention contains subject matter related to Japanese Patent Application JP 2007-271348 filed in the Japan Patent Office on Oct. 18, 2007, the entire contents of which being incorporated herein by reference.

### BACKGROUND OF THE INVENTION

1. Field of the Invention

The present invention relates to a book-shaped display apparatus capable of displaying, as still images, multiple pieces of frame data that constitute a video, and a method of editing a video using the book-shaped display apparatus.

2. Description of the Related Art

Japanese Patent Laid-Open No. 2004-279631 is an example of related art.

There have been provided a variety of business-use and consumer video editing devices. In recent years, in particular, so-called non-linear editors, which are realized by the use of a dedicated machine or a general-purpose personal computer, have enabled video editing with improved flexibility and efficiency.

### SUMMARY OF THE INVENTION

However, such existing video editing devices demand users to perform complicated operations, thus demanding considerable skill of the users.

As such, the present invention provides a device that enables the user to check contents of a video easily, and enables the user to edit the video with intuitive operations.

According to one embodiment of the present invention, there is provided a book-shaped display apparatus including: a cover portion; a plurality of sheet portions each formed by a flexible paper-like display device; and a spine portion that binds the cover portion and the plurality of sheet portions, so that the book-shaped display apparatus has a book-like structure with the sheet portions constituting pages.

The book-shaped display apparatus further includes: an external interface section configured to receive, from an external device, pieces of frame data that constitute a video; a storage section configured to store the pieces of frame data received via the external interface section; a sheet display control section configured to drive each of the sheet portions to present a display; and a control section configured to generate display image data for each of the sheet portions using the frame data stored in the storage section, supply the generated display image data to the sheet display control section, and control the sheet display control section to present a still image display on each of the sheet portions.

According to another embodiment of the present invention, there is provided a method of editing a video using a book-shaped display apparatus including a cover portion, a plurality of sheet portions each formed by a flexible paper-like display device and having an operation input section used for an editing operation, and a spine portion that binds the cover portion and the sheet portions, so that the book-shaped display apparatus has a book-like structure with the sheet portions constituting pages. The method includes the steps of: inputting and storing pieces of frame data that constitute the video in the book-shaped display apparatus; generating display image data for each of the sheet portions using the stored frame data, and presenting a still image display on each of the sheet portions using the generated display image data; generating video edit data based on an operation performed using the operation input section; and transmitting and outputting the video edit data generated in the generating of the video edit data to an external device.

According to the above embodiments of the present invention, a user of the book-shaped display apparatus is able to view the plurality of sheet portions while flipping through the sheet portions as if turning pages of a book.

For example, the user may download motion video(s) from an external non-linear editor into the book-shaped display apparatus in video units (e.g., units of video materials called clips, scenes, and so on). In this case, pieces of frame data that constitute the video unit are spread over the sheet portions and displayed thereon as still images. As a result, the user is able to view contents of the video unit with a feeling as if he or she were reading a book or a comic book.

In particular, when the images are displayed on the sheet portions in such a manner that the pieces of frame data that constitute the video progress continuously or intermittently along a time axis of the video with progress of the pages constituted by the sheet portions, the feeling of “reading a book,” i.e., a feeling that the direction in which the pages progress corresponds with a direction of the time axis, is in agreement with the progress of the video.

Also, the user is able to grasp contents of the video while viewing the sheet portions with a feeling as if he or she were reading a book or a comic book. Accordingly, the user is able to search for editing points (e.g., an in-point and an out-point) during this process.

When the user has performed an editing operation, video edit data may be generated in accordance with the editing operation and then transferred to the external device such as the non-linear editor. Thus, the external device is able to cause the edit to be reflected in original data.

According to an embodiment of the present invention, the pieces of frame data that constitute the video are spread over and displayed on the plurality of sheet portions. Thus, the user is able to check the contents of the video easily with a feeling as if he or she were reading a book. In addition, the user is able to perform editing operations, such as specifying editing points in the video, with a feeling as if he or she placed a bookmark between pages of a book. Thus, editing tasks can be achieved with intuitive and very simple operations.

### BRIEF DESCRIPTION OF THE DRAWINGS

FIG. 1 is a perspective view of an edit book according to one embodiment of the present invention;

FIGS. 2A and 2B are diagrams illustrating a book-like structure of the edit book according to the embodiment of the present invention;

FIGS. 3A and 3B are diagrams illustrating sheets of the edit book according to the embodiment of the present invention;

FIGS. 4A, 4B, and 4C are diagrams illustrating electronic paper used as the sheets according to the embodiment of the present invention;

FIG. 5 is a block diagram illustrating an internal structure of the edit book according to the embodiment of the present invention;

FIG. 6 is a diagram illustrating the edit book according to the embodiment of the present invention and a non-linear editor;

FIG. 7 is a flowchart illustrating a procedure for editing using the edit book according to the embodiment of the present invention;

FIG. 8 is a flowchart illustrating a clip download process performed by the edit book according to the embodiment of the present invention;

FIG. 9 is a diagram illustrating motion information included in download data according to the embodiment of the present invention;

FIGS. 10A and 10B are diagrams illustrating download packets according to the embodiment of the present invention;

FIG. 11 is a flowchart illustrating a thumbnail display process performed by the edit book according to the embodiment of the present invention;

FIG. 12 is a flowchart illustrating a process of spreading a video clip performed by the edit book according to the embodiment of the present invention;

FIGS. 13A, 13B, 13C, and 13D are graphs illustrating relationships between fps for frames spread over the sheets and the motion information, according to the embodiment of the present invention;

FIG. 14 is a flowchart illustrating a sheet editing process performed by the edit book according to the embodiment of the present invention;

FIG. 15 is a flowchart illustrating a cover editing process performed by the edit book according to the embodiment of the present invention;

FIGS. 16A and 16B are diagrams illustrating exemplary displays presented on a cover display section according to the embodiment of the present invention;

FIGS. 17A and 17B are diagrams illustrating other exemplary displays presented on the cover display section according to the embodiment of the present invention;

FIGS. 18A and 18B are diagrams illustrating still other exemplary displays presented on the cover display section according to the embodiment of the present invention;

FIGS. 19A and 19B are diagrams illustrating an exemplary display presented on the sheet according to the embodiment of the present invention;

FIG. 20 is a diagram illustrating another exemplary display presented on the sheet according to the embodiment of the present invention;

FIGS. 21A and 21B are diagrams illustrating exemplary displays presented on the sheets according to variations of the embodiment of the present invention; and

FIGS. 22A, 22B, 22C, and 22D are diagrams illustrating how edit books according to variations of the embodiment of the present invention are used.

### DETAILED DESCRIPTION OF THE PREFERRED EMBODIMENT

Hereinafter, a preferred embodiment of the present invention will be described in the following order. In this embodiment, an “edit book” capable of downloading images from a non-linear editor and performing an edit on the downloaded images will be described. This edit book is a book-shaped display apparatus according to one embodiment of the present invention.
[1. Structure of edit book]
[2. Internal structure of edit book]
[3. Procedure for editing using edit book]
[4. Download of video materials]
[5. Clip selection and displaying of images on sheets]
[6. Image editing process and upload of edit data]
[7. Effects and exemplary variations of embodiment]

### [1. Structure of Edit Book]

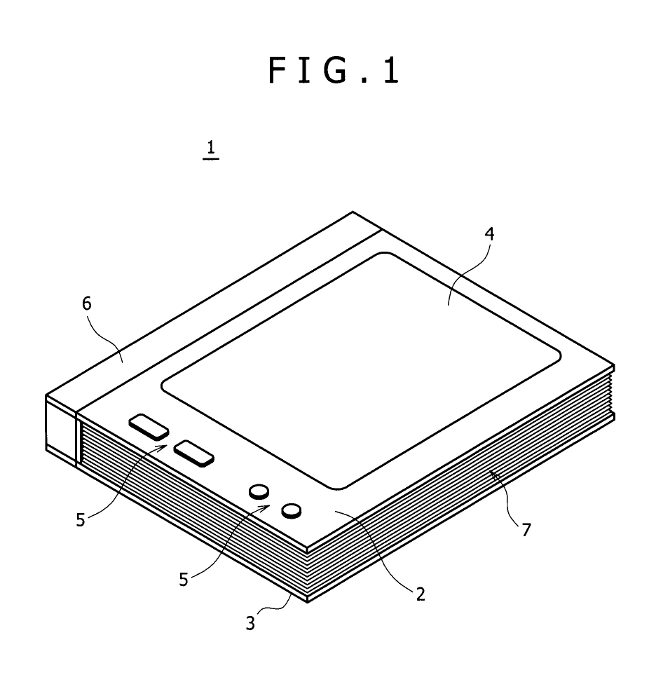

FIG. 1 shows a perspective view of an edit book 1 according to one embodiment of the present invention.

The edit book 1 has front and back cover portions 2 and 3, a plurality of sheets 7 placed between the cover portions 2 and 3, and a spine portion 6 that binds the cover portions 2 and 3 and the sheets 7, thus having a book-like structure with the sheets 7 constituting pages.

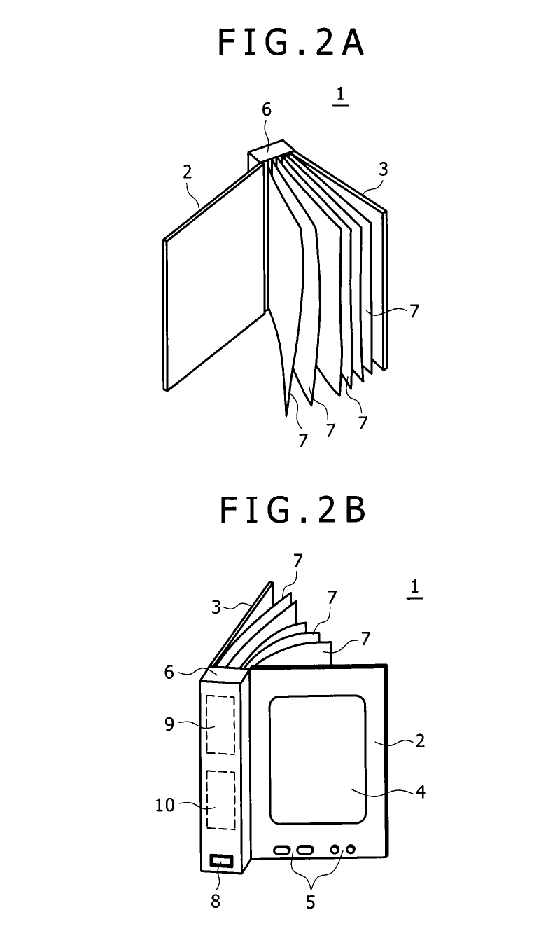

As illustrated in FIG. 2A, a user can open the edit book 1 to view the sheets 7 from one to another with a feeling as if he or she read a common book. Each sheet 7 is constituted by a flexible paper-like display device. Accordingly, the user is able to view contents displayed on each sheet 7 with a feeling as if he or she read a book. That is, the user is able to view the sheets 7 while turning the sheets 7 one by one or flipping through the sheets 7.

The cover portion 2 has a cover display section 4 and operation keys 5.

The cover display section 4 is formed by a liquid crystal panel or an organic electroluminescence (EL) panel, for example. The cover display section 4 is capable of displaying various types of visual information, including videos.

The cover display section 4 contains a touch sensor, thus being capable of accepting a touching operation on a display surface. Specifically, various operation-use images (e.g., operation button images) are displayed on the cover display section 4, and the user can perform a touch panel operation of touching the operation-use images to initiate a variety of operations. For example, thumbnail images representing video clips may be displayed on the cover display section 4. In this case, the user can touch one of the thumbnail images to initiate an operation such as selecting or specifying the image, for example.

The operation keys 5 are provided as operation units for power-up, power-off, display mode selection, and so on, for example. Note that any number of operation keys 5, which have a physical form, may be provided. Only a minimum number of operation keys 5 may be provided that are requisite to initiate operations that are necessary but cannot be initiated by the above touch panel operation. For example, only one key used for the power-up and the power-off may be provided.

Needless to say, as the operation keys 5, a large number of physical keys or dials may be provided that are used to initiate a variety of operations including the operations that can be initiated by the above touch panel operation as well.

The spine portion 6 of the edit book 1 is a portion that binds the cover portions 2 and 3 and the sheets 7. As illustrated in FIG. 2B, the spine portion 6 contains a circuit board 9 and a battery 10.

The spine portion 6 has a connection terminal 8 for data communication with an external device (e.g., the non-linear editor) in accordance with a predetermined communication system, such as USB (Universal Serial Bus) or IEEE (Institute of Electrical and Electronics Engineers) 1394.

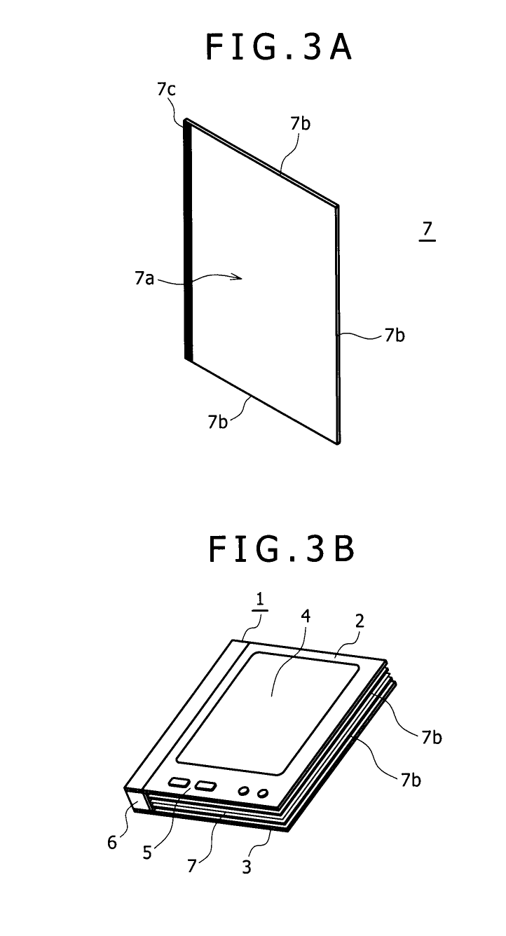

FIG. 3A illustrates the sheet 7. The sheet 7 is formed by an electronic paper, for example. A front surface of the sheet 7 is a main display section 7a.

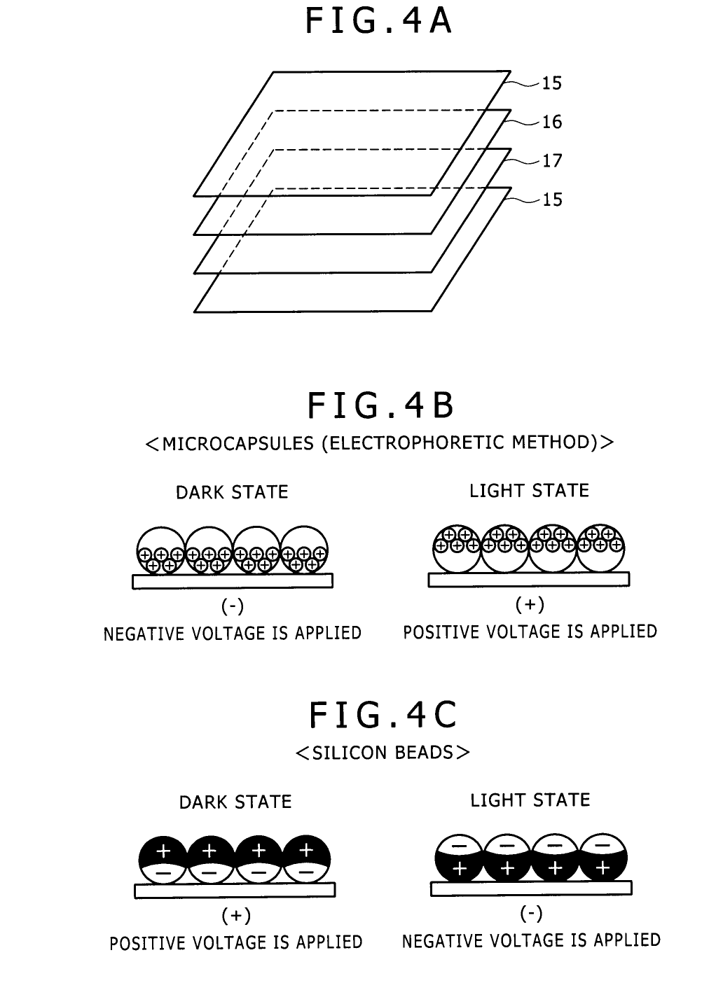

The electronic paper will now be briefly described below with reference to FIGS. 4A, 4B, and 4C.

FIG. 4A illustrates a common structure of the electronic paper. The electronic paper has two plastic sheets 15, a display layer 16, and a driver layer 17. The display layer 16 and the driver layer 17 are placed between the two plastic sheets 15.

The display layer 16 is a layer on which pixel structures using microcapsules, silicon beads, or the like are formed to display visual information.

The driver layer 17 is a layer on which display driving circuits using, for example, thin film transistors (TFTs) are formed. The driver layer 17 applies voltage to the pixel structures on the display layer 16 to cause the display layer 16 to display an image.

A display principle will now be described below with reference to FIGS. 4B and 4C.

FIG. 4B illustrates an electrophoretic method using the microcapsules.

Electrophoresis refers to a phenomenon of charged particles that are dispersed in liquid moving through the liquid under the action of an external electric field.

On the display layer 16, microcapsules containing blue liquid and white charged particles (titanium oxide particles) are arranged as the pixel structures. When a negative voltage is applied from the driver layer, the charged particles are attracted toward an electrode as illustrated in the figure. When this happens, the pixel structures enter a state in which the blue liquid is displayed, and this state corresponds to a “dark” state on the display.

On the other hand, when a positive voltage is applied from the driver layer, the charged particles repel the positive voltage to gather toward an upper side of the microcapsules. When this happens, the pixel structures enter a state in which the white charged particles are displayed, and this state corresponds to a “light” state on the display.

FIG. 4C illustrates a system using the silicon beads. In this system, solid particles (i.e., the silicon beads), each having two parts with different colors as illustrated in the figure, are used. In each of the silicon beads, each part having a different color is charged differently. Accordingly, each silicon bead rotates depending on the polarity of the voltage applied from the driver layer 17. Assume here that one of the two parts is colored black and the other part is colored white. Then, when the positive voltage is applied, for example, the black part becomes positively charged and faces toward the display surface, resulting in the color of black being displayed. On the other hand, when the negative voltage is applied, the white part becomes negatively charged and faces toward the display surface, resulting in the color of white being displayed.

Color display is possible with both the systems as illustrated in FIGS. 4B and 4C. Each microcapsule or silicon bead forms one pixel structure. Pixels corresponding to the colors of yellow, magenta, cyan, and black (YMCK), for example, may be arranged for the pixel structures, and each of the four pixels may be controlled with a different color signal to accomplish the color display.

Energy is demanded for the electrophoresis and the rotation of the silicon beads. Thus, the positive or negative voltage is selectively applied to cause each pixel to enter the “dark” or “light” state. While no voltage is applied, the state of each pixel remains the same. Therefore, if no voltage is applied after an image is displayed by applying an appropriate voltage to each pixel, the image being displayed continues to be displayed. Therefore, once an image is displayed, that image can continue to be displayed for a certain period of time even while no power is supplied.

Note that flexible transistors (organic transistors) using organic molecules, for example, may be used as the TFTs on the driver layer 17. In this case, the electronic paper, having a layered structure as illustrated in FIG. 4A, is formed as a flexible sheet. It is assumed in the present embodiment that each of the sheets 7 is formed as a flexible sheet having such a structure, for example, and that each sheet 7 can be handled as if it were a page of a book.

Also note that a touch sensor layer may be added to the structure as illustrated in FIG. 4A. For example, the touch sensor layer may be placed between the plastic sheet 15 and the display layer 16. In this case, the sheet 7 is capable of accepting the touch panel operation. It is assumed in the present embodiment that the sheet 7 is capable of accepting the touch panel operation.

The sheet 7 in the present embodiment is formed as such an electronic paper, and the main display section 7a as shown in FIG. 3A displays an image (a still image).

While the front surface of each sheet is formed as the main display section 7a, three end faces (e.g., three of the four end faces, except for a binding margin portion 7c) of the electronic-paper sheet are formed as end face display sections 7b.

Each of the end face display sections 7b is configured to be capable of red display, blue display, and the like, for example.

While the end face display section 7b is performing the red display, the blue display, or the like, the user is able to easily identify the sheet whose end face display section 7b is performing the red display, the blue display, or the like, when the edit book 1 is closed as illustrated in FIG. 3B.

### [2. Internal Structure of Edit Book]

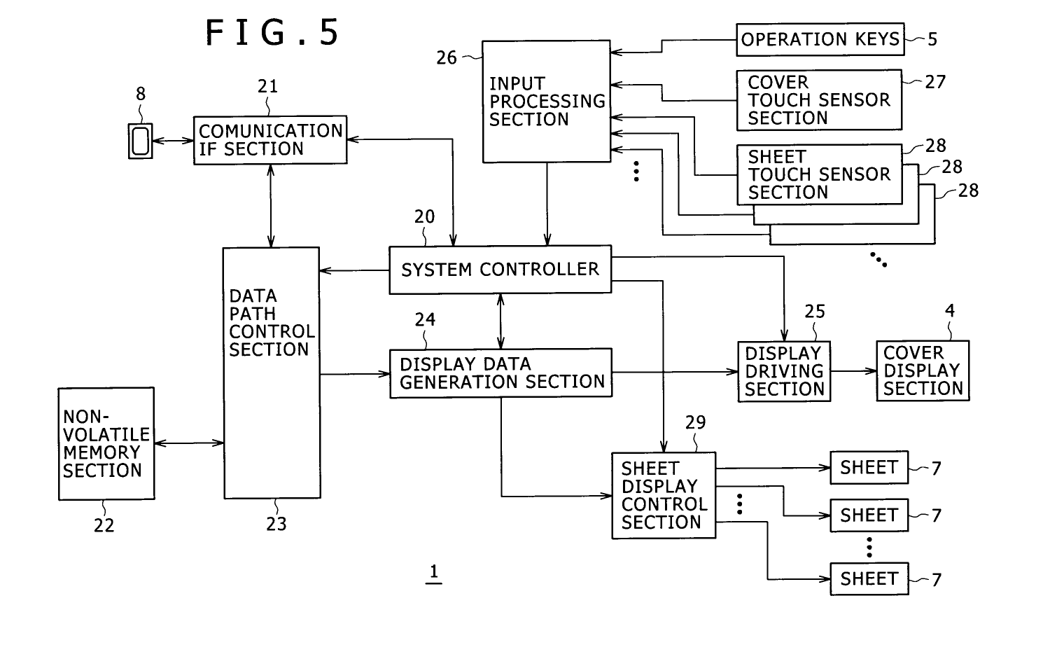

FIG. 5 shows an exemplary internal circuit structure of the edit book 1.

A system controller 20 is formed by a microcomputer having a central processing unit (CPU), a read only memory (ROM), a random access memory (RAM), and an interface section, for example. The system controller 20 is a control section for controlling a whole of the edit book 1. The system controller 20 performs control to allow an operation of communicating with a non-linear editor 100, which will be described later, a display operation at the cover display section 4, a display operation at the sheets 7, and so on to be performed in accordance with an operation program held therein and user operations.

A communication interface section 21 performs an operation of communicating with the external device (e.g., the non-linear editor 100) connected thereto via the connection terminal 8. For example, the communication interface section 21 receives data downloaded from the non-linear editor 100, and also performs, as a process for transmitting edit data to the non-linear editor 100, reception and transmission, encoding and decoding, and so on of packets to be communicated.

A non-volatile memory section 22 is a memory used primarily for storing the downloaded data supplied from the external device, such as the non-linear editor 100, the edit data generated by the system controller 20, and so on. That is, the non-volatile memory section 22 stores data that should be stored even while the power is off. Examples of the downloaded data include data of frames constituting a video (this data will be hereinafter referred to as “frame data” as appropriate), and information that accompanies the frame data.

A typical example of the non-volatile memory section 22 is a solid-state memory such as a flash memory. Alternatively, the non-volatile memory section 22 may be formed by a combination of a portable storage medium, such as a memory card containing the flash memory or the like or an optical disc, and a recording/reproducing section for the portable storage medium. Further, a hard disk drive (HDD) may be adopted as the non-volatile memory section 22.

Under control of the system controller 20, a data path control section 23 transfers data between the non-volatile memory section 22, the communication interface section 21, and a display data generation section 24. Examples of the data transferred include: data to be communicated, such as the downloaded data; image data to be used for a display on the cover display section 4; and image data used for a display on the sheets 7.

Under control of the system controller 20, the display data generation section 24 generates display data to be displayed on the cover display section 4, and display data to be displayed on the sheets 7. For example, the display data generation section 24 uses the frame data read from the non-volatile memory section 22 to generate the display data.

After generating the display data to be displayed on the cover display section 4, the display data generation section 24 supplies the generated display data to a display driving section 25. The display driving section 25 includes a pixel driving circuit system for the cover display section 4, and causes the cover display section 4 to perform a display operation based on the supplied display data.

Meanwhile, after generating the display data to be displayed on the sheets 7, the display data generation section 24 supplies the generated display data to a sheet display control section 29.

The sheet display control section 29 supplies the supplied display data to the corresponding sheets 7, and controls the sheets 7 to present displays based on the respective display data.

An input processing section 26 detects the user operation, and provides information about the user operation to the system controller 20.

That is, the input processing section 26 detects the operation performed on the operation keys 5 provided on the cover portion 2 or the like as described above, and provides information about the operation performed on the operation keys 5 to the system controller 20.

A cover touch sensor section 27 is the touch sensor provided in the cover display section 4, and detects a position at which the user has touched a screen of the cover display section 4. The input processing section 26 provides, to the system controller 20, input information representing the position on which the user has performed the operation. The system controller 20 associates the operation position with a corresponding position in a content of a display (i.e., an image content of the display data generated by the display data generation section 24) presented on the cover display section 4 at the time to identify a content of the user operation.

Sheet touch sensor sections 28 are touch sensors each provided in a separate one of the sheets 7. Each touch sensor section 28 detects a position at which the user has touched on a screen of the corresponding sheet 7. The input processing section 26 provides, to the system controller 20, input information representing the position at which the user has performed the operation on the screen of the sheet 7. The system controller 20 associates the operation position with a corresponding position in a content of a display (i.e., an image content of the display data generated by the display data generation section 24) presented on the sheet 7 at the time to identify a content of the user operation.

### [3. Procedure for Editing Using Edit Book]

Video editing using the edit book 1 according to the present embodiment as described above will now be described below.

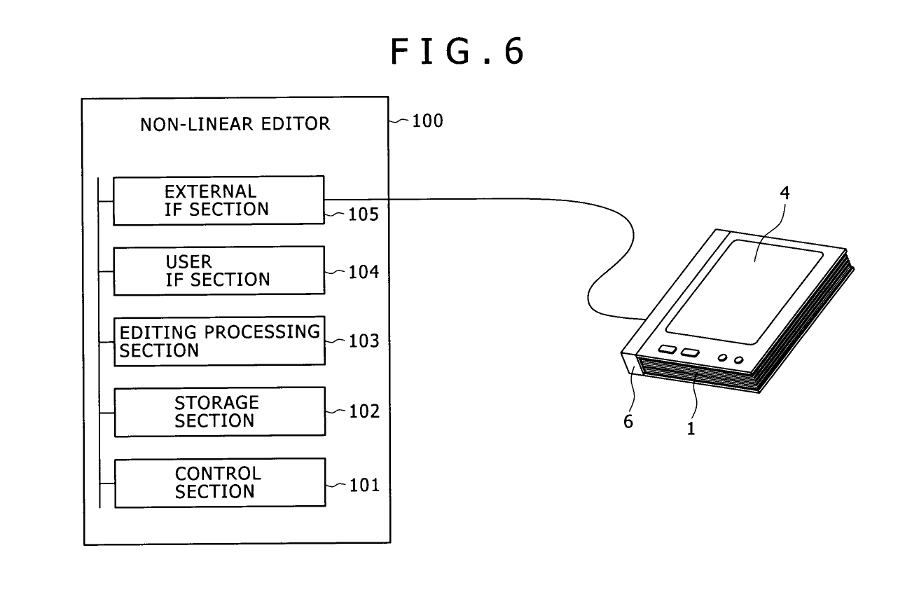

As one example of the video editing using the edit book 1 according to the present embodiment, the case will be described where a part (e.g., a cut editing) of editing work that can be performed using the non-linear editor 100 as shown in FIG. 6 is performed intuitively by using the edit book 1.

The non-linear editor 100 includes a control section 101, a storage section 102, an editing processing section 103, a user interface section 104, an external interface section 105, and so on, for example.

The control section 101 is formed by a microcomputer, for example, and controls an overall operation related to the video editing.

The storage section 102 is formed by an HDD or the like, for example, and stores video materials to be edited and the edit data.

The editing processing section 103 performs a variety of editing processes on the video materials.

The user interface section 104 includes an operation input system such as an operation key, a dial, a keyboard, a mouse, a touch panel, a touch pad, and so on, and an output system such as a display, an audio output section, and so on. The user interface section 104 performs various input/output operations in relation to a user (a human editor).

The external interface section 105 is a part for communicating with an external device. Examples of the external interface section 105 include a USB interface and an IEEE 1394 interface.

The non-linear editor 100 needs to be capable of communicating with the edit book 1, but in other respects, the non-linear editor 100 may be the same as a common video editing device. Specifically, for example, in hardware terms, the non-linear editor 100 needs to be capable of communicating with the edit book 1 via the external interface section 105, and in software terms, the non-linear editor 100 needs to have installed thereon an operation program to be executed by the control section 101 to perform an operation of allowing the frame data or the like to be downloaded to the edit book 1, and perform a process of accepting input of the edit data from the edit book 1.

The edit book 1 according to the present embodiment is capable of performing edits in conjunction with the non-linear editor 100.

When producing a “video content” (e.g., a video content for a broadcasting program, etc.) as a motion video produced by editing, for example, a plurality of clips may be subjected to the cut editing and then cuts are combined to form the video content. The term “clip” as used herein refers to a video unit, which is, for example, composed of a motion video shot continuously by a video camera between operations of starting shooting and stopping shooting. Note that the “clips” are sometimes referred to as “scenes.”

When the video content is produced in such a manner, one or more clips are captured into the non-linear editor 100 and stored in the storage section 102, as motion video materials to be edited.

Then, normally, using the non-linear editor 100, an in-point and an out-point are determined in each of the clips as the video materials, each clip is cut at the in-point and the out-point, and the resulting clips are combined in a specified order along a time axis.

Such an editing task is normally performed by a professional human editor using the non-linear editor 100, for example. In this case, an expert operational knowledge is necessary to perform editing tasks such as checking a content of each clip, specifying the in-point and the out-point, and so on.

The present embodiment facilitates such editing tasks by enabling the editing tasks to be performed with intuitive operations using the edit book 1 while easily checking the video contents.

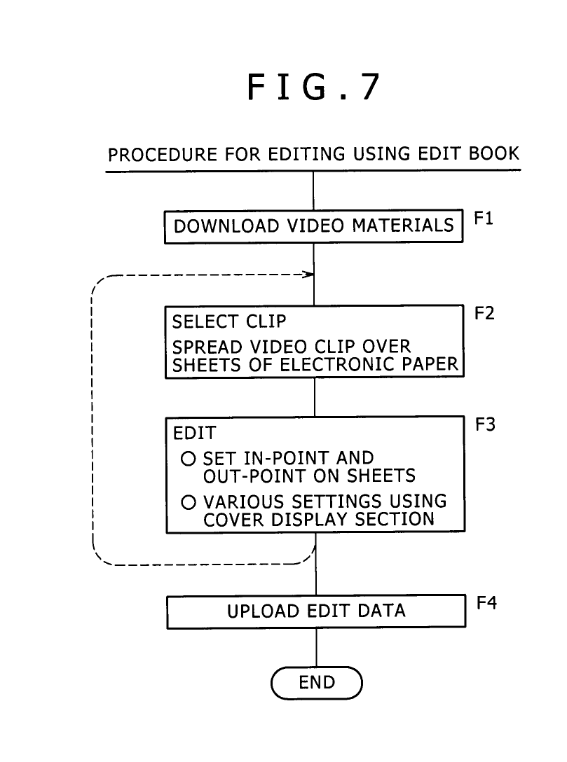

FIG. 7 illustrates an overall procedure of an editing operation performed by the edit book 1.

First, at step F1, the video materials are downloaded from the non-linear editor 100 to the edit book 1.

One or more clips to be used when producing the video content are stored, as the motion video materials to be edited, in the storage section 102 of the non-linear editor 100. At step F1, for example, the user connects the edit book 1 to the non-linear editor 100 in such a manner as shown in FIG. 6 so that the edit book 1 and the non-linear editor 100 are capable of performing data communication therebetween, and performs a necessary operation to cause the one or more clips that are stored in the non-linear editor 100 and to be used when producing the video content to be downloaded to the edit book 1. In the edit book 1, data of each of the clips is stored in the non-volatile memory section 22.

Next, at step F2, one clip is selected from among the downloaded clips, and frames that constitute the selected clip is spread over the electronic-paper sheets 7.

Each video clip is composed of a plurality of pieces of frame data, and the frames that constitute the motion video are displayed on the sheets 7, i.e., the pages, sequentially along the time axis.

As a result, the video clip is displayed on the edit book 1 as a series of continuous or intermittent frames such that the series of frames is displayed sequentially on one page/sheet to the next. Thus, the frames (i.e., still images) that constitute the video clip are spread over the pages, like frames in a comic book.

Since the frames that constitute the clip are spread over and displayed on the sheets 7, the user is able to check image contents of the selected clip with a feeling as if he or she were reading a book. That is, the user is able to easily check video contents of the clip advancing along the time axis, by turning the pages (i.e., the sheets 7) in sequential order or by flipping through the sheets 7, for example.

At step F3, setting of the in-point and the out-point is performed with the edit book 1 in the above state.

For example, the user performs an operation of setting the in-point and the out-point at a starting point and an end point of the cut editing, respectively, while checking the video contents with a feeling as if he or she were browsing a book. For example, while turning the pages, the user specifies one image on one page as the in-point and another image on another page as the out-point, with simple operations.

In response to such operations, the system controller 20 generates edit data about the in-point and the out-point.

Moreover, the cover display section 4 is capable of displaying the video of the clip, and the user is able to perform a variety of setting operations while checking the video displayed on the cover display section 4. Examples of such setting operations include an operation of adjusting a video level (e.g., a brightness level, a chroma level, etc.), and an operation of applying an image effect. The system controller 20 generates the edit data in accordance with such setting operations as well.

In summary, at steps F2 and F3, one clip is selected and then spread over the sheets 7, and the user performs editing while viewing the sheets 7 and/or the cover display section 4. As indicated by a dashed line, the processes of steps F2 and F3 are repeated each time the user selects one clip to be edited.

Note that, during a period of working processes of steps F2 and F3, the edit book 1 and the non-linear editor 100 perform no communication therebetween, and therefore the edit book 1 and the non-linear editor 100 do not need to be connected with each other during this period. That is, once the video materials are downloaded into the edit book 1 at step F1, the user who owns the edit book 1 is able to check the video contents of each downloaded clip and perform the editing work using the edit book 1 at any time and at any place.

When the user has judged that necessary editing has been completed with respect to each clip, the edit data that have been generated with respect to each clip are uploaded to the non-linear editor 100. That is, the user connects the edit book 1 to the non-linear editor 100 in such a manner as shown in FIG. 6 so that the edit book 1 and the non-linear editor 100 are capable of communicating with each other, and performs an upload operation. As a result, the system controller 20 of the edit book 1 performs a process of transferring the edit data to the non-linear editor 100.

The non-linear editor 100 stores the edit data transmitted from the edit book 1 in the storage section 102, and, treating the stored edit data as edit data generated based on operations on the non-linear editor 100 itself, causes the stored edit data to be reflected in a result of editing the video clips.

In the present embodiment, roughly speaking, the editing using the edit book 1 is performed in accordance with the above procedure.

### [4. Download of Video Materials]

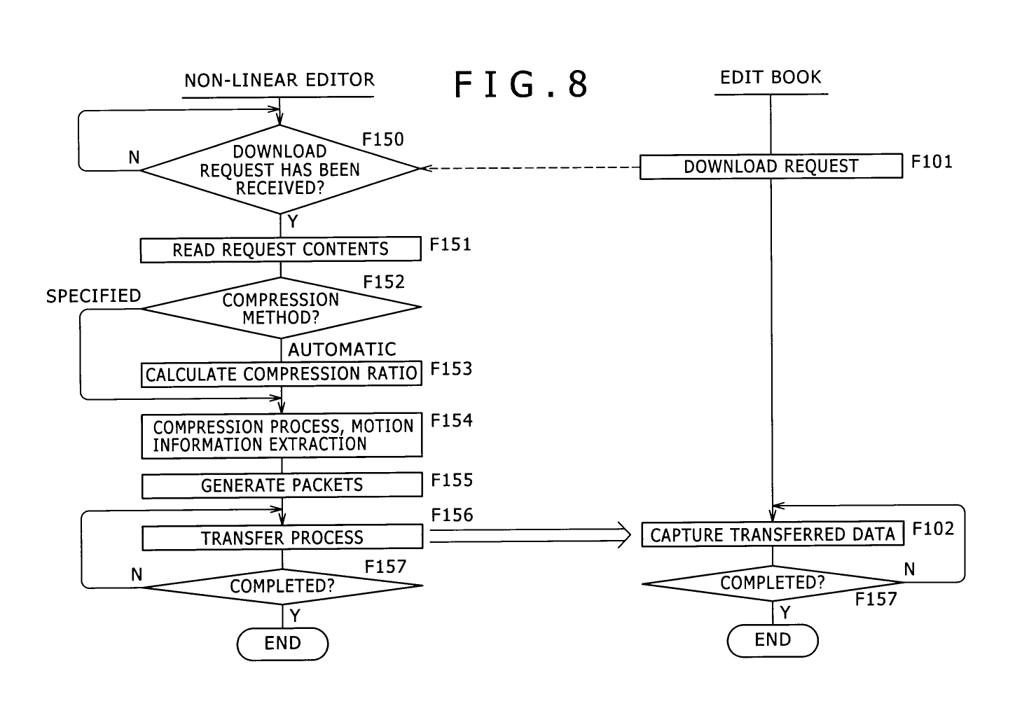

Here, a specific example of the operation of downloading the video materials at step F1 as shown in FIG. 7 will be described with reference to FIGS. 8, 9, 10A, 10B, 16A, 16B, 17A, and 17B.

Note that there are a variety of applicable operation procedures for the download and a variety of applicable user interfaces displayed, for example, on the cover display section 4, but that only one of the applicable operation procedures and only one of the applicable user interfaces will be described here.

First, the download operation will be described from the standpoint of the user interface.

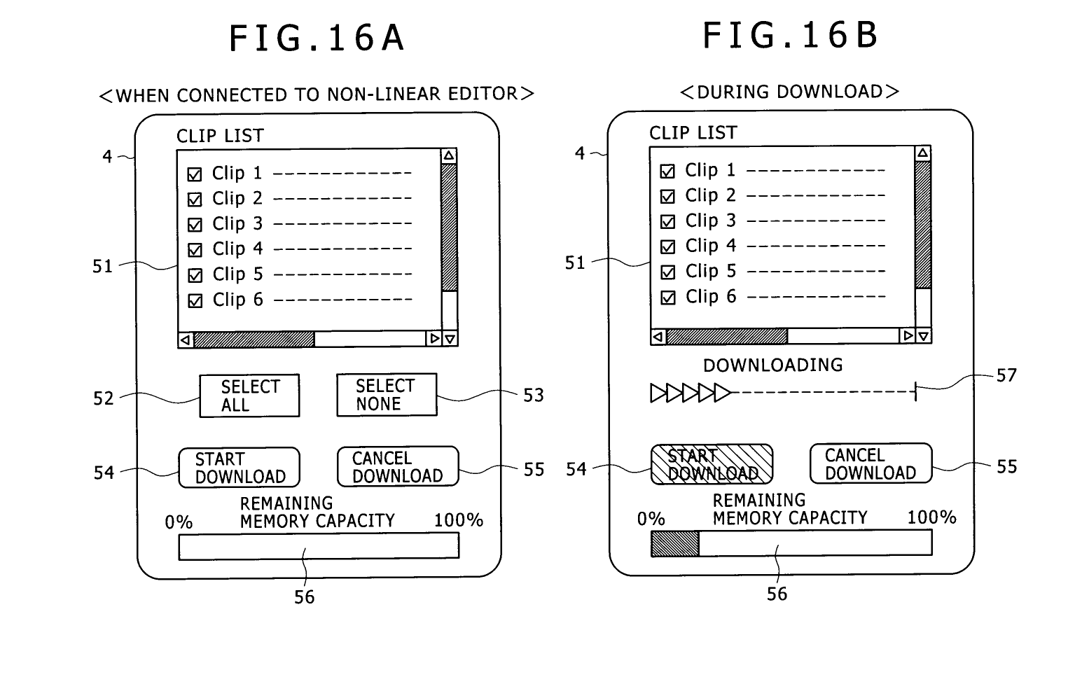

For example, when the edit book 1 has been connected to the non-linear editor 100 as shown in FIG. 6 and communication has been established therebetween, the system controller 20 of the edit book 1 receives information from the non-linear editor 100 to cause the cover display section 4 to present a display as shown in FIG. 16A.

That is, when the connection between the edit book 1 and the non-linear editor 100 has been established, the system controller 20 automatically communicates with the control section 101 of the non-linear editor 100 to receive information about a list of the clips, i.e., the video materials, stored in the non-linear editor 100 (i.e., in the storage section 102 thereof). Then, the system controller 20 causes the display data generation section 24 to generate display data including the information about the list and an image for the user operation, and causes the cover display section 4 to present the display as shown in FIG. 16A.

In the example of FIG. 16A, a clip list display 51, operation button displays 52, 53, 54, and 55, and a remaining memory capacity indicator 56 are presented.

The clip list display 51 represents the list of the clips stored in the non-linear editor 100. For example, for each of the clips, attribute information, such as a clip name (i.e., “Clip 1,” “Clip 2,” and so on in the figure), a data size (a total time of hours/minutes/seconds/frames as the motion video), and a shooting date/time, is displayed along with a check box.

In the case where the number of clips in the list is too large, or in the case where too much information is displayed as the attribute information about each clip, vertical and horizontal scroll bars may be displayed as shown in FIG. 16A to enable the user to scroll the list vertically and horizontally by user operations (e.g., a touch operation on the scroll bars).

As the operation button displays 52, 53, 54, and 55, displays of operations such as “Select All,” “Select None,” “Start Download,” and “Cancel Download” are presented.

The operation button display 52, “Select All,” is an operation-use image for an instruction to select all the clips in the clip list display 51.

The operation button display 53, “Select None,” is an operation-use image for an instruction to make all the clips in the clip list display 51 unselected.

The operation button display 54, “Start Download,” is an operation-use image for an instruction to start download of the clips selected in the clip list display 51.

The operation button display 55, “Cancel Download,” is an operation-use image for an instruction to cancel the download operation.

The remaining memory capacity indicator 56 indicates the current remaining memory capacity of the non-volatile memory section 22 visually, using a bar indicator, for example.

When the above displays are presented on the cover display section 4, for example, the user of the edit book 1 is able to select one or more desired clips which he or she desires to download (i.e., desires to edit with the edit book 1) from among the clips, i.e., the video materials, stored in the non-linear editor 100. The user is able to arbitrarily select the one or more clips which he or she desires to download, by performing a touch operation(s) on the clip list display 51, or by performing a touch operation on the operation button display 52, “Select All,” for example.

After selecting the one or more clips, the user may perform a touch operation on the operation button display 54, “Start Download,” to start the download of the selected clip(s).

After the download is started, the system controller 20 instructs the display data generation section 24 to present a display as shown in FIG. 16B.

As shown in FIG. 16B, for the clips selected by the selecting operation performed by the user before the operation button display 54, “Start Download,” is pressed, checkmarks are displayed in the corresponding check boxes in the clip list display 51 (in the example of FIG. 16B, “Clip 1” to “Clip 6” are selected).

During the download operation, a download operation progress indicator 57 is displayed as shown in FIG. 16B to indicate the degree of the progress of the download operation. In addition, the remaining memory capacity indicator 56 indicates that the remaining memory capacity of the non-volatile memory section 22 decreases gradually with the progress of the storage of the downloaded data in the non-volatile memory section 22.

At this time, the operation button display 54, “Start Download,” is not necessary for the user operation, and therefore becomes inactive.

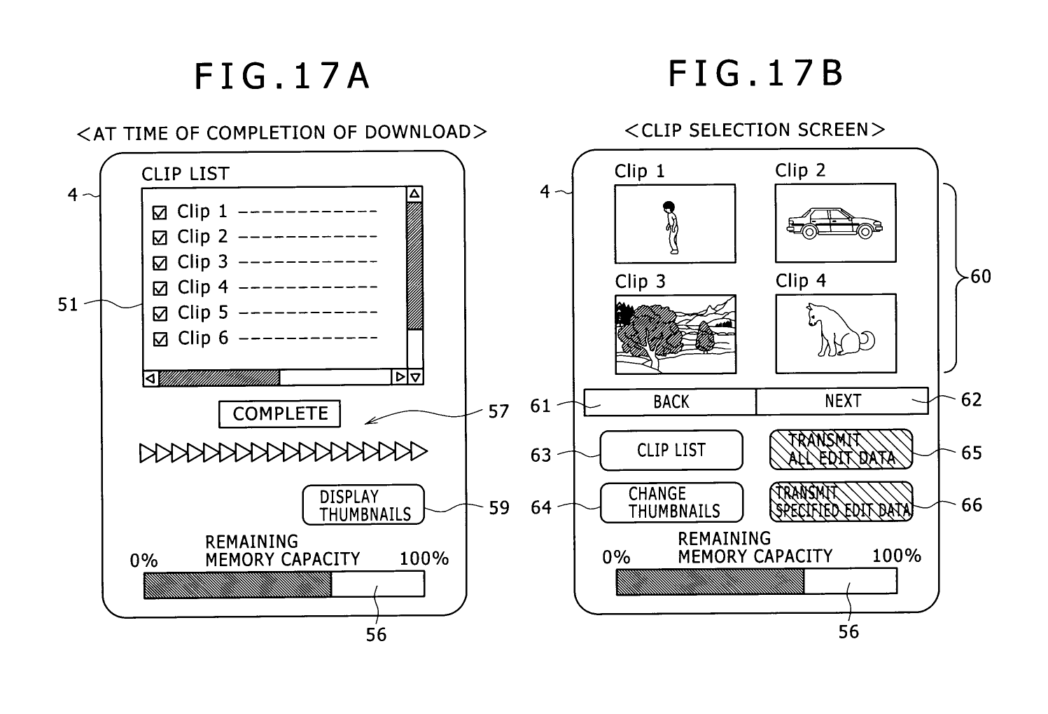

When the download operation is completed thereafter, the system controller 20 causes the download operation progress indicator 57 on the cover display section 4 to indicate completion of the download as shown in FIG. 17A. The remaining memory capacity indicator 56 indicates the remaining memory capacity of the non-volatile memory section 22 at the time of the completion of the download.

In a period between the connection of the edit book 1 to the non-linear editor 100 and the completion of the download, the system controller 20 causes the cover display section 4 to present the displays as described above, and also present various types of information and images for the user operations as the user interface related to the download operation.

FIG. 8 illustrates a procedure at the time of the download. FIG. 8 shows a procedure performed by the system controller 20 of the edit book 1 and a procedure performed by the control section 101 of the non-linear editor 100 after the touch operation is performed on the operation button display 54, “Start Download,” as shown in FIG. 16A.

If the user selects the clips to be downloaded on the clip list display 51 and presses the operation button display 54, “Start Download,” the system controller 20 transmits a download request to the non-linear editor 100 at step F101.

At this time, the system controller 20 generates, as information for the download request, a packet including a code representing the download request, information about the current remaining memory capacity of the non-volatile memory section 22, and information about the selected clips, for example. This packet may additionally include information about a specified compression ratio for the image data. Regarding specification of the compression ratio, the user may be allowed to perform an operation of specifying a desired compression ratio. When the user has performed such an operation of specifying the compression ratio, the packet may include the information about the specified compression ratio. Alternatively, the user may be allowed to perform an operation of specifying a desired compression ratio for each clip when selecting the clips. In this case, the above packet may include information about the specified compression ratios of the respective clips.

After generating such a download request packet, the system controller 20 transfers the generated packet to the communication interface section 21, and causes the communication interface section 21 to transmit the packet to the non-linear editor 100.

If the control section 101 of the non-linear editor 100 detects reception of the download request from the edit book 1 via the external interface section 105, control proceeds from step F150 to F151, and the control section 101 reads the contents of the download request packet.

After reading the contents of the packet, the control section 101 determines a compression method. If the download request packet includes the information about the specified compression ratio, the control section 101 decides to compress the images at the specified compression ratio. Meanwhile, if the download request packet does not include the information about the specified compression ratio (i.e., the compression ratio has not been specified), the control section 101 automatically sets the compression ratio.

In the case where the control section 101 automatically sets the compression ratio, control proceeds to step F153, and the control section 101 calculates the compression ratio. In this case, the control section 101 checks a total data amount of the one or more clips selected as the clips to be downloaded and the information about the remaining memory capacity of the non-volatile memory section 22 of the edit book 1, which are included in the download request packet, and calculates such a compression ratio as allows the one or more clips selected as the clips to be downloaded to be stored in the non-volatile memory section 22.

Although not shown in FIG. 8, in some cases, it may be determined that no compression ratio allows the download of the clips to be downloaded because the remaining memory capacity of the non-volatile memory section 22 is too limited. In that case, an error notification may be transmitted to the edit book 1 to allow the system controller 20 of the edit book 1 to display a message to prompt the user to perform a necessary operation (e.g., reselecting the clips, deleting some data in the non-volatile memory section 22, etc.) to cope with this problem.

When the control section 101 has set the compression ratio at step F153, control proceeds to step F154. Meanwhile, in the case where the download request packet includes the information about the specified compression ratio, control proceeds from step F152 to F154.

At step F154, the control section 101 performs a compression process on pieces of frame data that constitute the clips to be downloaded, and also performs a process of extracting motion information.

As to the compression process, the pieces of frame data that constitute the video clips are subjected to the compression process at the compression ratio set at step F153 or at the specified compression ratio. For example, each piece of frame data is subjected to a still image/frame compression process according to the JPEG (Joint Photographic Experts Group) standard or the like.

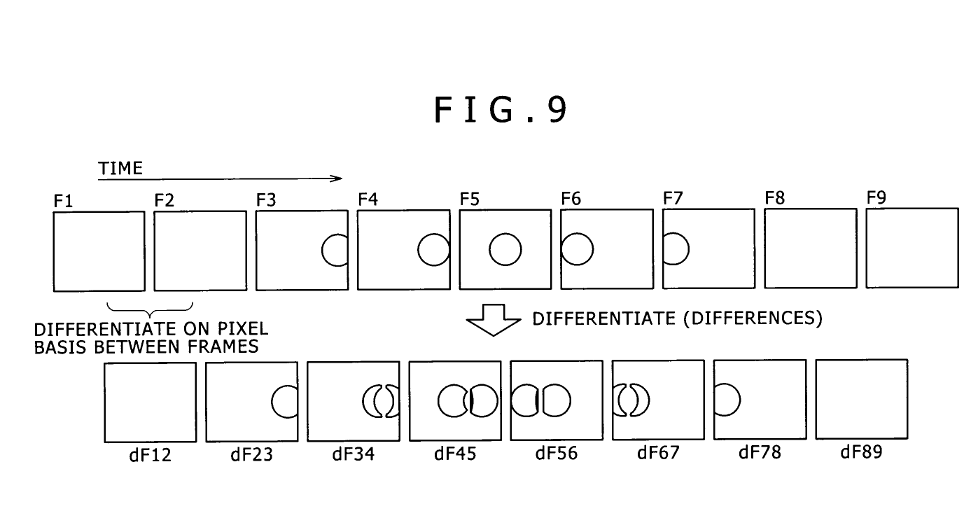

The motion information is information about the degree of motion concerning the pieces of frame data that constitute the video. The process of extracting the motion information is schematically illustrated in FIG. 9.

The motion information detected about the motion video is, generally, numerical values representing changes between frames. Assume that frames F1, F2, . . . and F9 as shown in FIG. 9 are the pieces of frame data that constitute the video as arranged along the time axis.

With respect to frames F1, F2, . . . , and F9, differences between every two frames that are continuous in time are calculated on a pixel-by-pixel basis, and an absolute value thereof is divided by the total number of pixels to determine an average value of the differences. This value is the motion information.

The bottom row of FIG. 9 represents differences dF12, dF23, . . . , and dF89 between each pair of neighboring frames F1, F2, . . . , and F9. For example, difference dF12 is the difference between frames F1 and F2, and difference dF23 is the difference between frames F2 and F3.

Values corresponding to the above differences dF12, dF23, . . . , and dF89 can be detected as the motion information in the above-described manner.

This motion information is information that reflects the degree of motion in an entire screen.

Note that the motion information may be generated by performing motion detection with respect to a specific object in the frames, instead of the entire frames. For example, a “person,” a “car,” or the like may be specified as such an object. In the case where a “person” is specified as such an object, an image recognition process is performed on each frame to determine whether the frame includes an image of the “person,” and difference detection is performed with respect to a pixel area of the “person” to generate the motion information. That is, in this case, the generated motion information is motion information concerning the “person” in the video. In the case where the specified object is not a person, similarly, the image recognition process is performed to extract a pixel range corresponding to the object, and the difference detection is performed with respect to the pixel range.

After the compression process and the process of extracting the motion information are completed at step F154, control proceeds to step F155, and the control section 101 generates download packets (i.e., packets to be downloaded to the edit book 1).

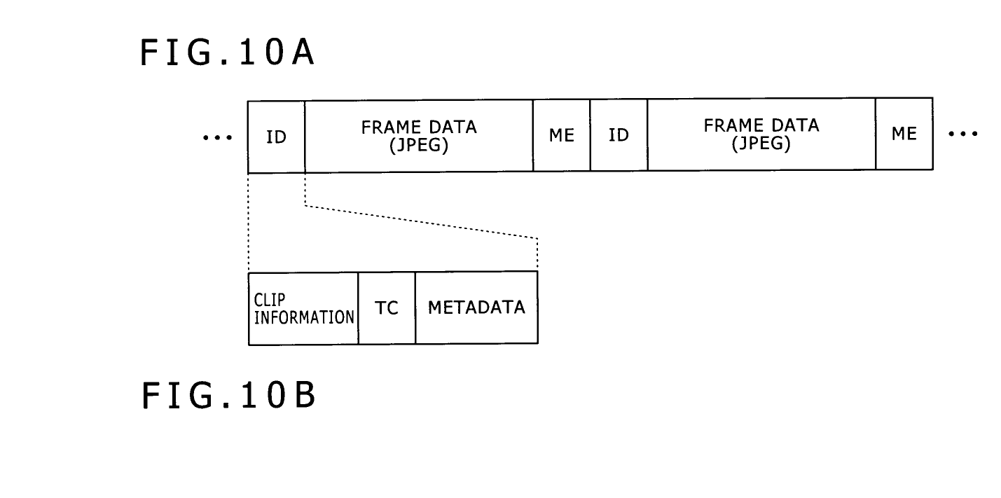

FIG. 10A shows an example of the download packets. Each download packet is composed of an ID, frame data, and motion information ME, for example.

The frame data in this case is image data of one frame compressed in accordance with the JPEG standard, for example.

As illustrated in FIG. 10B, the ID includes clip information, a time code TC, and metadata. The clip information is identification information of a clip that contains this frame data. A first frame in the clip is assigned a time code TC “00:00:00:00” (hours:minutes:seconds:frames), and the value of the time code progresses within the clip, for example. The metadata is a variety of additional data added to the clip.

After generating the download packets as described above, the control section 101 performs a process of transferring the download packets at step F156. That is, the control section 101 supplies the download packets to the external interface section 105, and causes the external interface section 105 to transmit the download packets to the edit book 1.

Then, the control section 101 performs the generation of the download packets and the transferring process for all the specified clips sequentially, and finishes this downloading process when the transmission of all download packets for the specified clips has been completed.

After transmitting the download request packet at step F101, the system controller 20 of the edit book 1 waits for the download packets, and if the transmission of the download packets by the non-linear editor 100 is started in accordance with the above-described procedure, the system controller 20 performs, at step F102, a process of capturing the download packets transferred from the non-linear editor 100.

Specifically, if the communication interface section 21 starts receiving the download packets, the system controller 20 instructs the data path control section 23 to write the download packets as decoded to the non-volatile memory section 22.

If the reception of the download packets and the writing of the download packets to the non-volatile memory section 22 are completed with respect to all the specified clips, the downloading process is finished.

While the download packets are being captured at step F102, the system controller 20 causes the cover display section 4 to present the display as illustrated in FIG. 16B. After the capture of the download packets is completed, the system controller 20 causes the cover display section 4 to present the display as illustrated in FIG. 17A.

While a detailed description is omitted here, an interruption of communication, a transmission error, a shortage of capacity of the non-volatile memory section 22, or the like may occur during the transfer of the download packets at steps F156 and F102. When such a problem occurs, the problem will naturally be handled appropriately. Needless to say, the downloading process may end in an error without being completed.

The download of the video clips to the edit book 1 is performed as the above-described operation, for example.

It has been assumed in the exemplary procedures of FIG. 8 that the user performs the operation of selecting the clip(s) to be downloaded and the operation of starting the download using the edit book 1. Note, however, that these operations may be performed using the non-linear editor 100.

Also note that it may be so arranged that the user selects one or more clips to be downloaded to the edit book 1 in advance by manipulating the non-linear editor 100, and that the operation of downloading the one or more clips selected in advance is automatically started when the edit book 1 has been connected to the non-linear editor 100 so as to be capable of communicating therewith.

### [5. Clip Selection and Displaying of Images on Sheets]

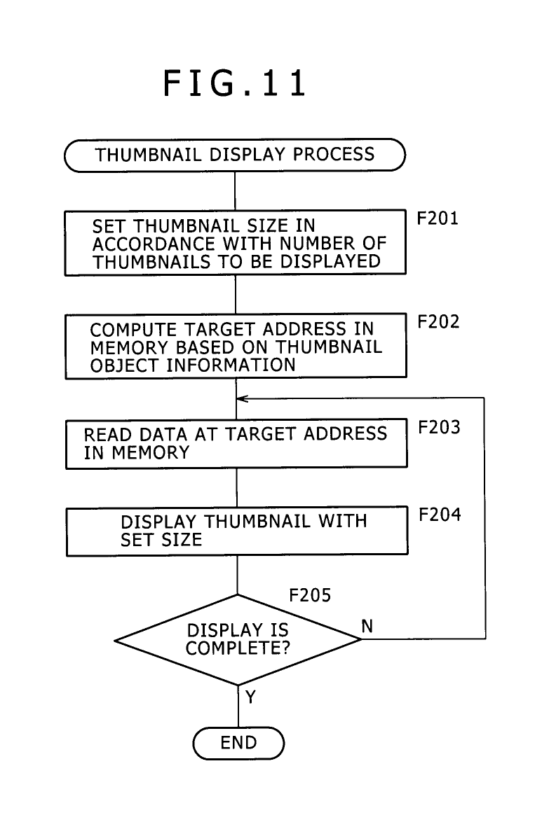

Next, clip selection and the spreading of the frames of the clip over the sheets 7 in the edit book 1, which are performed at step F2 as shown in FIG. 7, will now be described below with reference to FIGS. 11, 12, 13A, 13B, 13C, 13D, 17A, 17B, 19A, and 19B.

When the download operation as described above has been completed, the user is informed of the completion of the download by the cover display section 4 as illustrated in FIG. 17A.

An operation button display 59, “Display Thumbnails,” is presented on the screen as shown in FIG. 17A. If the user performs a touch operation on the operation button display 59, “Display Thumbnails,” the system controller 20 presents a clip selection screen display as illustrated in FIG. 17B.

Alternatively, the system controller 20 may present the clip selection screen display as illustrated in FIG. 17B automatically upon completion of the download.

As illustrated in FIG. 17B, a thumbnail display 60 concerning the downloaded clips is presented in the clip selection screen display. Each thumbnail represents one of the clips.

In addition, operation button displays 61 and 62, “Back” and “Next,” and operation button displays 63, 64, 65, and 66, “Clip List,” “Change Thumbnails,” “Transmit All Edit Data,” and “Transmit Specified Edit Data,” are presented.

In this example, the remaining memory capacity indicator 56, which indicates the remaining memory capacity of the non-volatile memory section 22, continues to be presented.

The operation button displays 61 and 62, “Back” and “Next,” are operation-use images for instructions to turn pages in the thumbnail display 60 backward and forward when thumbnails of all the downloaded clips cannot be displayed on one screen.

The operation button display 63, “Clip List,” is an operation-use image for an instruction to cause the clip selection screen to be replaced by the screen for displaying the clip list as illustrated in FIG. 16A.

The operation button display 64, “Change Thumbnails,” is an operation-use image for an instruction to change a method for generating the thumbnails for the respective clips (i.e., to change objects to be displayed as the thumbnails).

The operation button displays 65 and 66, “Transmit All Edit Data” and “Transmit Specified Edit Data,” are operation-use images for instructions to upload the edit data to the non-linear editor 100 after finishing the editing work. When no editing has been performed, i.e., when no edit data has been generated, the operation button displays 65 and 66, “Transmit All Edit Data” and “Transmit Specified Edit Data,” are inactive because they do not need to be operated.

This clip selection screen is displayed to allow the user to select a clip which he or she desires to edit or whose image contents he or she desires to check, by selecting the thumbnail image therefor. In other words, the user is able to select the clip which he or she desires to edit or whose contents he or she desires to check, by specifying the thumbnail image therefor.

FIG. 11 illustrates a procedure performed by the system controller 20 to present the thumbnail display 60.

When presenting the thumbnail display 60, the system controller 20 first sets the size of the thumbnail images at step F201 in accordance with the number of thumbnails to be displayed.

In the case where one thumbnail is displayed for each clip, the number of thumbnails to be displayed corresponds to the number of downloaded clips.

While four thumbnails are displayed on one screen in FIG. 17B, the number of thumbnails displayed on one screen may be variable. For example, the size of each thumbnail image may be decreased to display more thumbnails on one screen.

Although it is possible to turn the pages in the thumbnail display 60 backward and forward by operating the operation button displays 61 and 62, “Back” and “Next,” operability in selecting the clip by means of the thumbnail will be increased as the number of thumbnail images displayed on one screen increases.

Meanwhile, a decrease in size of the thumbnail images will result in a reduction in visibility of the thumbnail images, which represent the contents of the clips.

Accordingly, a reasonable minimum size is set with respect to the size of the thumbnails, for example, and within this limitation, the size of the thumbnails is set in accordance with the number of downloaded clips so that as many thumbnails as possible will be displayed on one screen.

Next, at step F202, the system controller 20 computes a target address in the non-volatile memory section 22 based on thumbnail object information. Here, the target address is an address from which frame data based on which the thumbnail is to be generated is to be read.

In the case where the thumbnail display 60 is presented on the cover display section 4 in accordance with the procedure of FIG. 11, for example, not only the presentation of the thumbnail display 60 (clip selection-use thumbnails) used for the clip selection as illustrated in FIG. 17B but also the presentation of thumbnails of frames in a single clip (clip image content check-use thumbnails) is possible, for example.

The “clip selection-use thumbnails” corresponds to a thumbnail display in which each clip is represented by one thumbnail, whereas the “clip image content check-use thumbnails” corresponds to a thumbnail display in which contents of a specific clip are represented by a plurality of thumbnails.

The term “thumbnail object information” as used herein refers to information that indicates whether the thumbnails to be displayed should be the “clip selection-use thumbnails” or the “clip image content check-use thumbnails” for a specific clip, for example.

In the case where the clip selection screen as illustrated in FIG. 17B is to be displayed, the thumbnail object information indicates the “clip selection-use thumbnails,” thereby specifying that one thumbnail should be displayed for each clip.

Note that the user may be allowed to specify how the thumbnail object is set for the thumbnail display 60. For example, if the user presses the operation button display 64, “Change Thumbnails,” as illustrated in FIG. 17B, the system controller 20 may display a screen for selecting the “clip selection-use thumbnails” or the “clip image content check-use thumbnails” as the thumbnail object.

Then, if the user selects the “clip selection-use thumbnails” or the “clip image content check-use thumbnails,” the thumbnail object information, which is checked at step F202, is set based on which the user has selected.

It may be so arranged that the “clip selection-use thumbnails” is selected as an initial setting, and that the process of displaying the “clip selection-use thumbnails” as illustrated in FIG. 17B is performed in the procedure of FIG. 11, unless the user presses the operation button display 64, “Change Thumbnails.”

In the case where the “clip selection-use thumbnails” is set, for example, the user may be allowed to choose, with respect to each clip, which frame data is to be used to generate the thumbnail image.

In the case where one piece of frame data is extracted from one clip to generate the thumbnail image for the clip, for example, the piece of frame data extracted may be data of a top frame of the clip, data of an xth frame (as counted from the top) of the clip, or data of a frame that has been marked as a representative frame, for example.

Thus, the manner of extracting the one piece of frame data from the clip may be set in advance as the thumbnail object information. Alternatively, it may be so arranged that the user is allowed to specify the manner after pressing the operation button display 64, “Change Thumbnails,” and that information that specifies the frame data to be extracted is included in the thumbnail object information in accordance with the manner specified by the user.

After setting the target address in the non-volatile memory section 22 based on the thumbnail object information at step F202, the system controller 20 performs control to read the one piece of frame data at step F203. Then, the system controller 20 controls the frame data read from the non-volatile memory section 22 to be transferred to the display data generation section 24, and at step F204 controls the display data generation section 24 to generate the thumbnail image from the frame data. At this time, the system controller 20 notifies the display data generation section 24 of the thumbnail size set at step F201, and controls the display data generation section 24 to generate the thumbnail image with the specified size. Then, the system controller 20 controls the generated thumbnail image to be supplied to the display driving section 25, and controls the cover display section 4 to display the generated thumbnail image.

The processes of steps F203 and F204 are repeated until it is determined at step F205 that the displaying of the thumbnail images has been completed.

In such a manner, the thumbnail images of the clips are displayed one after another, and when it is determined at step F205 that the displaying of the thumbnail images has been completed, the presentation of the thumbnail display 60, concerning the plurality of clips, as illustrated in FIG. 17B is completed, for example.

Note that when one of the operation button displays 61 and 62, “Back” and “Next,” has been pressed, the system controller 20 performs the procedure of FIG. 11 in a similar manner to present the thumbnail display 60 for the previous or next page.

In the procedure of FIG. 11, the thumbnail image is generated from the frame data when presenting the thumbnail display 60. Note, however, that it may be so arranged that the thumbnail image is generated for each clip and stored in the non-volatile memory section 22 in advance, and that, when presenting the thumbnail display 60, the thumbnail image of each clip is read from the non-volatile memory section 22 to be displayed.

When the thumbnail display 60 has been presented on the cover display section 4 as illustrated in FIG. 17B as a result of the above-described procedure, for example, the user is able to select any desired clip using the thumbnail display 60.

The system controller 20 recognizes the touch operation on the thumbnail image as an operation of selecting the clip.

When the user has selected a clip, the system controller 20 performs a process of spreading frames of the selected clip over the sheets 7.

If the user selects “Clip 1” using the thumbnail display 60 as illustrated in FIG. 17B, for example, frames of “Clip 1” will be spread over the sheets 7.

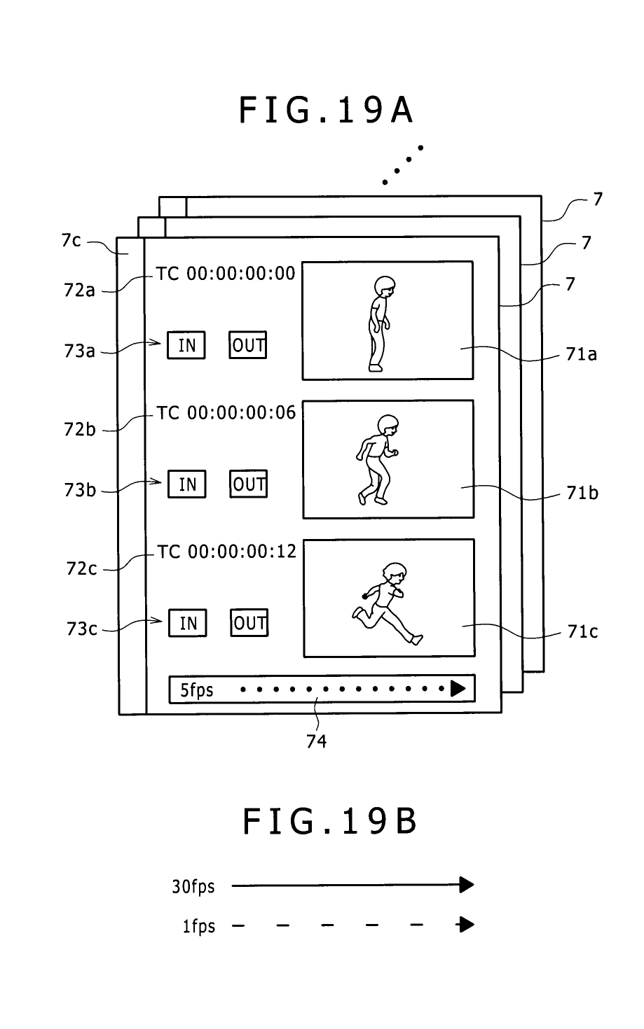

FIGS. 19A and 19B illustrate an exemplary display on the sheet 7.

FIG. 19A illustrates an exemplary case where three frames 71a, 71b, and 71c among a large number of frames constituting the clip are displayed on one sheet 7.

A time code 72a and an operation button display 73a are presented so as to be associated with the frame 71a. A time code 72b and an operation button display 73b are presented so as to be associated with the frame 71b. A time code 72c and an operation button display 73c are presented so as to be associated with the frame 71c.

Each of the operation button displays 73a, 73b, and 73c is an operation-use image for allowing the user to perform operations of specifying the frame 71a, 71b, or 71c as the in-point or the out-point in the cut editing.

The frames 71a, 71b, and 71c displayed on the sheet 7 are a series of frames that have been extracted from the pieces of frame data that constitute the clip continuously or intermittently along the time axis of the video.

For example, the time codes 72a, 72b, and 72c for the frames 71a, 71b, and 71c as illustrated in FIG. 19A indicate “00:00:00:00,” “00:00:00:06,” and “00:00:00:12,” respectively. In this case, fps (frames per second) is 5. In the case where the video clip is a 30 frames/s video, for example, five frames are extracted in one second, i.e., every sixth frame is extracted, and the extracted frames are displayed on the sheets 7.

In this case, frames whose time codes are “00:00:00:18,” “00:00:00:24,” and “00:00:00:30” are displayed on the sheet 7 (i.e., the page) next to the sheet 7 illustrated in FIG. 19A.

That is, the frames are displayed sequentially along the time axis of the video, from the top toward the bottom in each sheet 7 and from one sheet 7 to the next.

As a result, the user will be able to check the contents of the video clip by viewing the sheets 7, with a feeling as if he or she were reading a comic book, for example.

An image 74 that indicates an interval between neighboring frames as displayed is displayed at the bottom of the sheet 7. In the example of FIG. 19A, the image 74 indicates the frame rate “5 fps” and also indicates, by an arrow image, that the frames displayed are intermittent.

The image 74 is designed to help the user recognize a temporal feeling that the user would have when viewing the displayed images as a video. Accordingly, in order to make it easier for the user to recognize intuitively the interval between the neighboring frames displayed, the image 74 may be varied in accordance with the frame interval in a manner as illustrated in FIG. 19B.

For example, in the case of 30 fps, i.e., when all frames are displayed continuously, a shaft of the arrow image may be a solid line, whereas in the case where the frame interval is long, such as in the case of 1 fps, the shaft of the arrow image may be a dashed line whose dashes are spaced widely to a corresponding degree.

In FIG. 19A, the time codes 72a, 72b, and 72c and the operation button displays 73a, 73b, and 73c are displayed on the side closer to the binding margin portion 7c of the sheet 7, while the frames 71a, 71b, and 71c are displayed on the other side, opposite to the binding margin portion 7c. This arrangement makes it easier for the user to recognize the image contents when viewing the sheets 7 while flipping through the sheets 7.

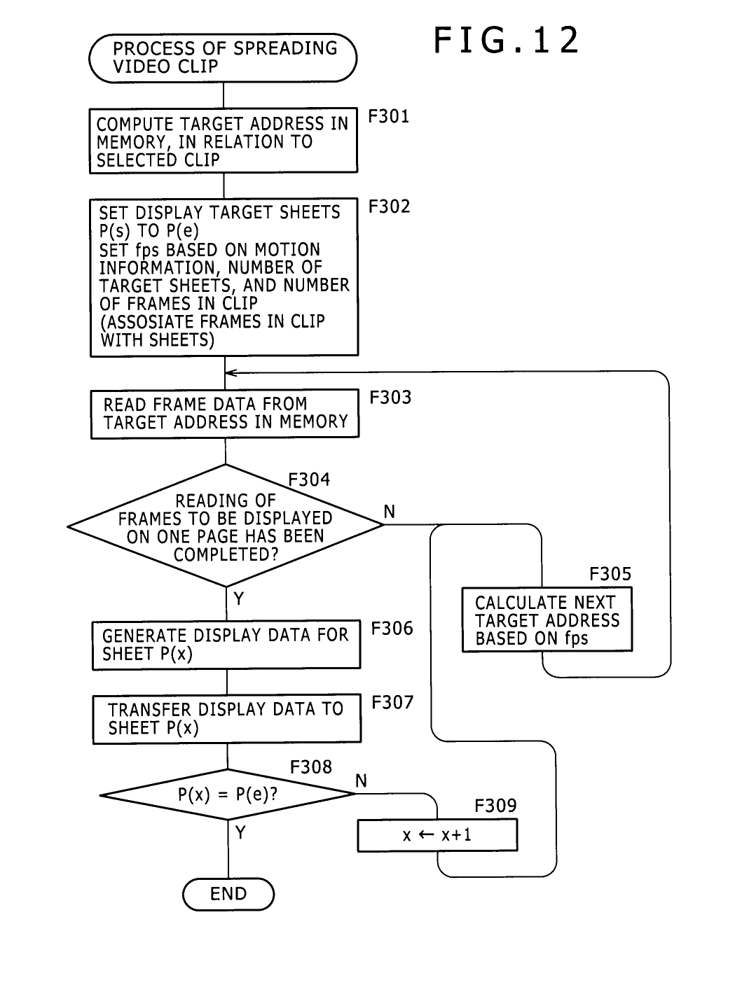

A procedure performed by the system controller 20 to spread the video clip over the sheets 7 will now be described below with reference to FIG. 12.

The system controller 20 starts the procedure of FIG. 12 when the clip is selected by the user operation on the thumbnail display 60 as illustrated in FIG. 17B, for example.

First, at step F301, the system controller 20 computes a target address, from which the frame data of the selected clip is to be read, in the non-volatile memory section 22. For example, the system controller 20 computes an address at which data of the top frame of the clip is stored, for example.

Next, at step F302, the system controller 20 sets a range of display target sheets as sheets P(s) to P(e), and also sets fsp mentioned above as a rate of the frames to be displayed on the sheets 7.

The range of the display target sheets is normally all pages of sheets 7 bound into the edit book 1. In the case where the edit book 1 has fifty sheets 7 in total and the fifty pages are available for displaying the frames, for example, the first to fiftieth sheets 7 may be set as the range of the display target sheets. Sheet P(s) refers to a sheet as a starting page, whereas sheet P(e) refers to a sheet as an end page. In the case where the images are to be spread over the fifty sheets 7, for example, values of 1 and 50 are set as sheet P(s) and sheet P(e), i.e., sheet P(s)=1 and sheet P(e)=50.

Note that in the case where the video clip is very short or where the frame interval is set to be very long, for example, the frames of the video clip may be spread over the sheets without using all the sheets. Therefore, sheets P(s) and P(e) may be set in accordance with the total number of frames in the clip, fps at the time of the spreading, and the number of pages, i.e., the number of sheets 7.

Also note that, it may be so arranged that images from one clip are spread over the first to twenty-fifth pages and images from another clip are spread over the twenty-sixth to fiftieth pages, for example. The system controller 20 may set sheets P(s) and P(e) considering such cases.

Further, fsp for the images to be spread over the sheets 7 is set based on the motion information, the number of target sheets, the total number of frames in the clip, and so on. There are a variety of methods conceivable for setting fsp.

For example, fsp may be set such that the frames will be displayed at regular intervals (or at substantially regular intervals), in accordance with the total number of frames in the clip and the number of target sheets.

Also, the user may be allowed to perform an operation of specifying the frame interval. In this case, fsp may be set in accordance with the user-specified frame interval, regardless of the total number of frames or the number of target sheets.

Also, since the data of the downloaded clip includes the motion information ME as described above, fsp may be set in accordance with this motion information ME.

For example, fsp may be set based on an average value of the motion information about the clip.

Also, different values of fsp may be set for different sections in the clip, each section being composed of a plurality of frames. That is, fsp may be varied for a section involving a large amount of motion and another section involving a small amount of motion, for example.

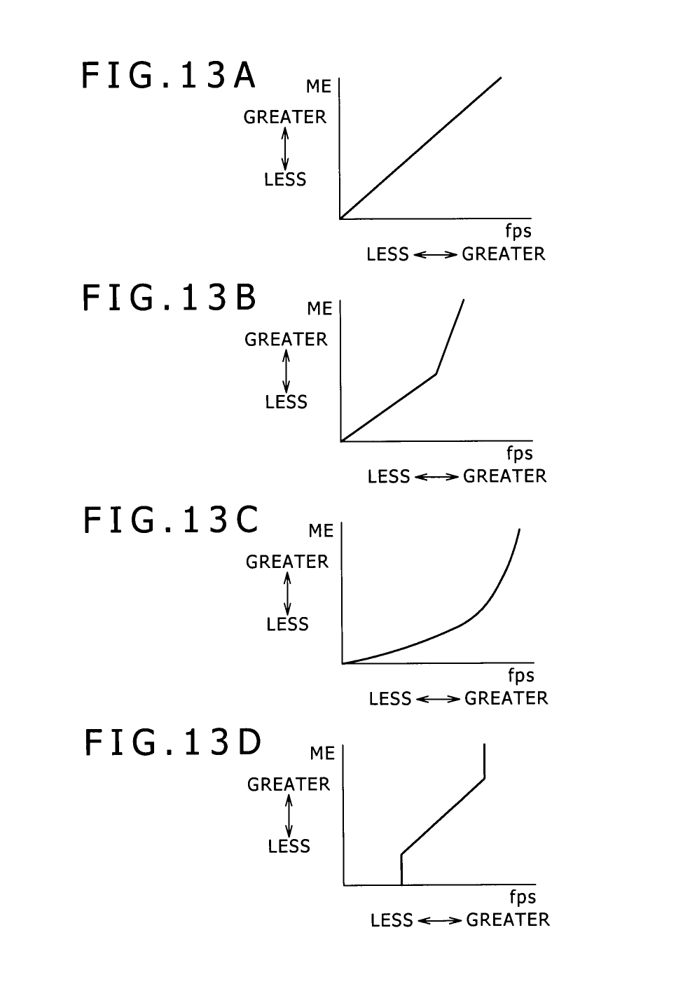

FIGS. 13A to 13D illustrate exemplary manners of setting fsp in accordance with the motion information ME.

FIG. 13A illustrates an exemplary manner of setting fsp in proportion to the degree of motion represented by the motion information ME. That is, in this example, greater values of fsp (i.e., shorter frame intervals) are set as the amount of motion between the frames increases.

FIG. 13B illustrates an exemplary manner of setting fsp in which the motion information ME and fsp have a nonlinear relationship. Note that as illustrated in FIG. 13C, this relationship may be such as represented by a quadric curve.

FIG. 13D illustrates an exemplary manner of setting fsp in which upper and lower limits are determined for the value of fps, and the value of fsp is set at the lower limit when the value of the motion information ME is below a threshold, while the value of fsp is set at the upper limit when the value of the motion information ME is above another threshold.

In the case where fsp is set in accordance with the motion in the video clip in the above-described manners, for example, the user will be able to check the frames extracted at appropriate intervals in accordance with the degree of motion in the video, when viewing the frames as spread over the sheets 7. In addition, the user will be able to check the contents of the video with an appropriate sense of motion, when flipping through the pages.

After the system controller 20 sets the range of the display target sheets, sheets P(s) to P(e), and fsp, control proceeds to step F303, and the system controller 20 first controls reading of the frame data from the target address in the non-volatile memory section 22.

First, the system controller 20 controls the reading of data of a top frame in the clip stored at the target address set at step F301, for example, and controls the frame data read from the non-volatile memory section 22 to be transferred to the display data generation section 24.

At step F304, the system controller 20 determines whether all images to be displayed on one page of sheet 7 have been read. In the case where three frames are to be displayed on one page as illustrated in FIG. 19A, the reading of all the images to be displayed on one page is completed when three frames have been read.

Therefore, at the time when the data of the first frame has been read, control proceeds to step F305, and the system controller 20 computes a next target address. The next target address is an address at which frame data to be displayed next, which is determined in accordance with fsp set, is stored. In the case where fsp=5 as in the example of FIG. 19A, for example, the next target address is an address at which data of a sixth frame in the clip is stored. Then, control returns to step F303, and the system controller 20 controls the reading of the frame data at the target address in the non-volatile memory section 22. Then, the system controller 20 controls the frame data read from the non-volatile memory section 22 to be transferred to the display data generation section 24.

At the time when the reading of the data of the three frames has been completed as a result of the processes of steps F303 and F305, the display data generation section 24 becomes able to generate the display data for one sheet 7. Accordingly, at the time when the reading of the data of the frames to be displayed on one page has been completed, control proceeds from step F304 to step F306, and the system controller 20 instructs the display data generation section 24 to generate the display data for sheet P(x). An initial value of “x” in sheet P(x) is “s” in sheet P(s) set at step F302. That is, the system controller 20 causes the display data for the first sheet 7 (i.e., the first page) to be displayed to be generated.

In accordance with the instruction from the system controller 20, the display data generation section 24 generates display data for the contents as illustrated in FIG. 19A, for example, i.e., the display data including the three frames 71a, 71b, and 71c, the time codes 72a, 72b, and 72c, the operation button displays 73a, 73b, and 73c, and the image 74 indicating fsp.

Then, at step F307, the system controller 20 causes the display data generated by the display data generation section 24 to be transferred to the sheet display control section 29 as the display data for sheet P(x) (which is sheet P(s), i.e., the first page, in the first iteration), and causes the sheet display control section 29 to present the display on sheet P(x). As a result, the display as illustrated in FIG. 19A is presented on sheet P(x), i.e., the first-page sheet 7.

At step F308, the system controller 20 determines whether P(x)=P(e), i.e., whether the displaying of all target sheets has been completed.

If not P(x)=P(e), control proceeds to step F309, and the system controller 20 increments variable x, and control proceeds to step F305. Then, control returns to step F303, and the above-described processes are repeated.

Thus, similar processes are performed at steps F303 to F307, with a second-page sheet 7 set as sheet P(x), so that a display is presented on the second-page sheet 7. These processes are repeated in a similar manner with respect to a third-page sheet 7, a fourth-page sheet 7, and so on, so that displays are presented thereon.

At the time when the display process is completed with respect to the last page of the display target sheets, sheet P(e), the system controller 20 determines that P(x)=P(e) at step F308. Thus, the system controller 20 determines that the displaying of all the target sheets has been completed, and finishes the procedure of FIG. 12, i.e., the procedure for spreading the frames of the video clip over the sheets 7.

As a result of the above-described procedure, the frames of the selected clip are spread over the sheets 7, and the user is able to check the video contents of the clip with a feeling as if he or she were browsing a book.

Although the setting of fsp for the frames to be displayed on the sheets 7 has been described above, fsp may be changed after the frames of the clip have once been spread over the sheets 7, for example, and then the frames of the clip may be spread over the sheets 7 again, with a new value of fsp.

For example, the user may be allowed to perform an operation for spreading the frames of the clip anew and an operation of specifying fsp, and the procedure of FIG. 12 may be performed again to perform the operation of spreading the frames of the clip over the sheets 7 in order to satisfy a desire of the user, such as a desire to view frames extracted at reduced intervals or a desire to view frames extracted at increased intervals, for example. In this case, needless to say, fsp is set at step F302 in accordance with a user operation.

Further, the user may be allowed to specify, while viewing the sheets 7, two frames to initiate a process of spreading the frames of the clip over the sheets anew so that frames extracted at reduced intervals between the two specified frames will be spread, for example.

In any case, the frame interval of the displayed frames can be varied by setting fsp appropriately at the time of the above frame-spreading process. By setting fsp appropriately, it is possible to display all the frames in the clip continuously and sequentially and also to display intermittent frames with a variety of frame intervals. Therefore, it is preferable that the frames can be spread over the sheets 7 with a variety of values of fsp in accordance with the user operation.

Still further, it is conceivable that, after the in-point and the out-point are set by an editing process as described below, frames between the in-point and the out-point are spread over the sheets 7 anew.

### [6. Image Editing Process and Upload of Edit Data]

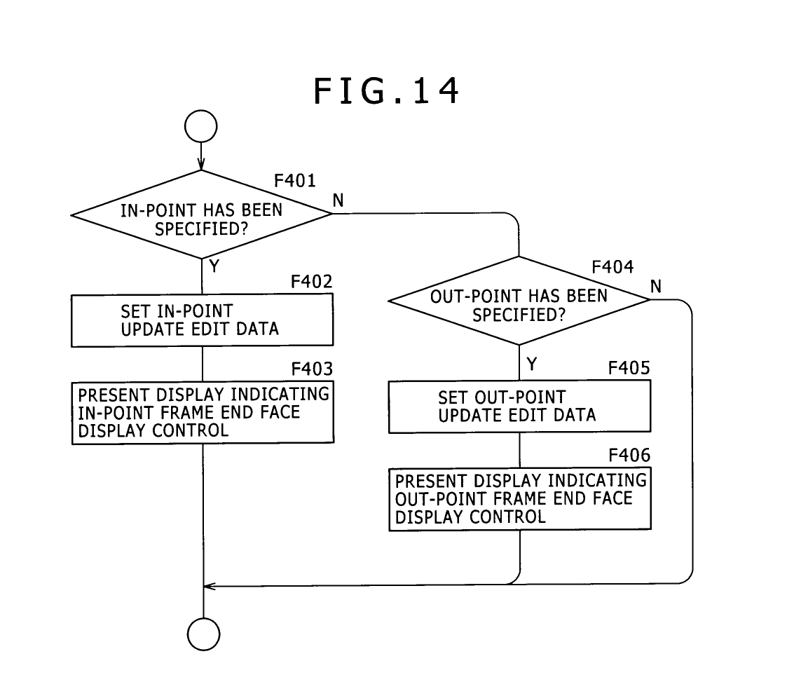

Next, as image editing using the edit book 1 according to the present embodiment, an editing process using the sheets 7 and an editing process using the cover display section 4 will now be described below with reference to FIGS. 14, 15, 18A, 18B, and 20. These processes correspond to step F3 as shown in FIG. 7.

When the frames of the video clip have been spread over the sheets 7 as described above, the user is able to perform the cut editing on the clip using the sheets 7. The cut editing refers to an editing operation of specifying the in-point and the out-point in the clip to specify a video section to be used for the video content.

Specification of the in-point and the out-point can be achieved very simply. As described above, the user is able to check the video contents of the clip by viewing the sheets 7 with a feeling as if he or she were browsing a book. During this process, the user may specify any desired frame as the in-point and any desired frame as the out-point.

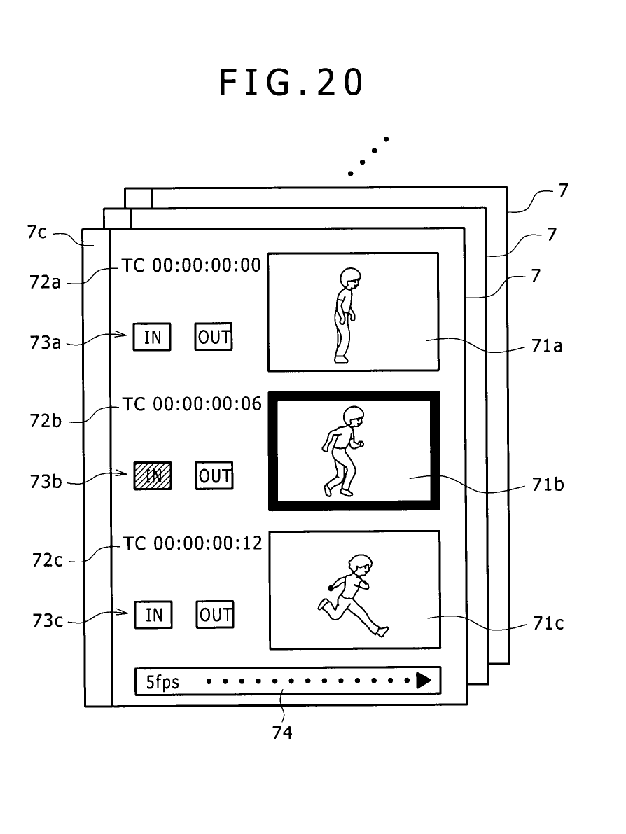

For example, the user can specify the frame 71b in the second row on the sheet 7 as illustrated in FIG. 20 as the in-point, by touching “In” in the operation button display 73b associated with the frame 71b. The sheet touch sensor section 28 is provided on each sheet 7 as described above, and the sheet touch sensor section 28 detects the position on which the user has performed the touch operation, and the input processing section 26 notifies the system controller 20 of the position on which the touch operation has been performed. When the position on which the touch operation has been performed corresponds to “In” in the operation button display 73b, the system controller 20 handles the touch operation as the operation of specifying the in-point. That is, when the touch operation on “In” in the operation button display 73b has been detected, the system controller 20 determines that the clip 71b with the time code “00:00:00:06” has been specified as the in-point, and generates corresponding edit data.

The same is true with the out-point as well. If the user performs the touch operation on “Out” in the operation button display associated with a certain frame on a certain sheet 7, i.e., a certain page, the system controller 20 determines that the user has performed the operation of specifying that frame as the out-point, and generates corresponding edit data.

FIG. 14 illustrates a procedure to be performed by the system controller 20 for accomplishing the editing process using the sheets 7 as described above.

At step F401, the system controller 20 monitors whether the operation of specifying the in-point has been performed. At step F404, the system controller 20 monitors whether the operation of specifying the out-point has been performed.

When the operation of specifying the in-point has been detected, control proceeds from step F401 to step F402, and the system controller 20 generates (updates) the edit data so that the time code of the frame that has been specified as the in-point will be set as the in-point.

At step F403, the system controller 20 performs control to present a display that clearly shows the user that the in-point has been specified. For example, as illustrated in FIG. 20, the system controller 20 controls the image of “In” in the operation button display 73b, on which the operation of specifying the in-point has been performed, to be changed into a specific color, e.g., red, and also displays a red frame, for example, around the frame 71b specified as the in-point. The system controller 20 instructs the display data generation section 24 to make such a change to the display, thereby causing the sheet display control section 29 to change the color in part of the display on the sheet in question and display the frame surrounding the frame 71b.

In addition, the system controller 20 causes end face display to be performed. As described above with reference to FIGS. 3A and 3B, each sheet 7 is equipped with the end face display sections 7b. The system controller 20 instructs the sheet display control section 29 to cause the end face display section 7b of the sheet 7 on which the operation of specifying the in-point has been performed to illuminate in red, for example.

When the operation of specifying the out-point has been detected, control proceeds from step F404 to step F405, and the system controller 20 generates (updates) the edit data so that the time code of the frame that has been specified as the out-point will be set as the out-point.

At step F406, the system controller 20 performs control to present a display that clearly shows the user that the out-point has been specified. For example, the system controller 20 controls the image of “Out” in the operation button display, on which the operation of specifying the out-point has been performed, to be changed into a specific color, e.g., blue, and also displays a blue frame, for example, around the frame specified as the out-point. The system controller 20 instructs the display data generation section 24 to make such a change to the display, thereby causing the sheet display control section 29 to change the color in part of the display on the sheet in question and display the frame surrounding the frame specified as the out-point.

In addition, the system controller 20 causes the end face display to be performed. The system controller 20 instructs the sheet display control section 29 to cause the end face display section 7b of the sheet 7 on which the operation of specifying the out-point has been performed to illuminate in blue, for example.

The specification of the in-point and the out-point is achieved in the above-described manner, and the system controller 20 generates edit data that represents the in-point and the out-point in the clip whose frames are spread over the sheets, in accordance with the user's operations of specifying the in-point and the out-point.

On the sheets 7, the in-point is clearly shown to the user because the image of “In” in the operation button display is in red and the in-point frame is surrounded by the red frame, whereas the out-point is clearly shown to the user because the image of “Out” in the operation button display is in blue and the out-point frame is surrounded by the blue frame.

Moreover, because the end face display sections 7b illuminate in red and blue, it is easy for the user to recognize on which pages the in-point and the out-point, i.e., cut editing points, are set even when the edit book 1 is closed, as illustrated in FIG. 3B.

Note that indicating the in-point and the out-point by the red and blue colors, respectively, is simply one example. The in-point and the out-point may be indicated by other colors or in other manners than using the color. For example, display contents may be changed to indicate the in-point and the out-point clearly to the user.

Next, editing using the cover display section 4 will now be described below.

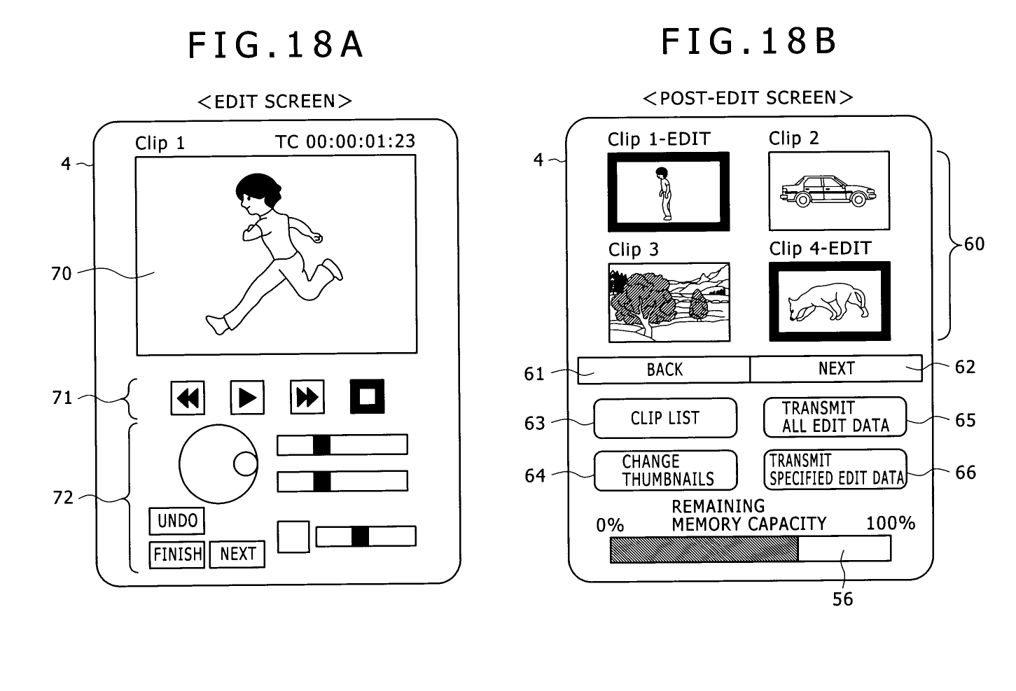

For example, after a particular clip is selected and the frames of the selected clip are spread over the sheets 7 as described above, an edit screen as illustrated in FIG. 18A is displayed on the cover display section 4.

In this edit screen, an image of the selected clip is displayed as a clip image display 70. In addition, operation unit images 71 related to video playback and operation unit images 72 used for the editing work are displayed as various operation unit displays.

As the operation unit images 71, images of operation buttons for play, fast reverse, fast forward, and stop are displayed, for example, so that the user can enter instructions related to the video playback by performing the touch operation thereon. The user is able to enter an instruction for play, fast reverse, fast forward, or stop of the video presented as the clip image display 70, by operating one of the operation unit images 71. The system controller 20 performs video playback control concerning the selected clip, in accordance with the touch operation on any of the operation unit images 71.

As the operation unit images 72 used for the editing work, a dial image, a fader image, button images, and so on are displayed, so that the user can perform a variety of editing operations by the touch operation.

For example, an operation of adjusting the brightness level or the chroma level as the video level, a motion control (video speed setting) operation, image effect operations such as operations for inverting, fade-in, and fade-out, operations for undoing an edit, ending the editing, advancing the editing, and so on can be performed by using the operation unit images 72.

Accordingly, the user is able to perform inputs of a variety of edit settings concerning the video level, the image effects, and so on, while viewing the motion video of the clip.

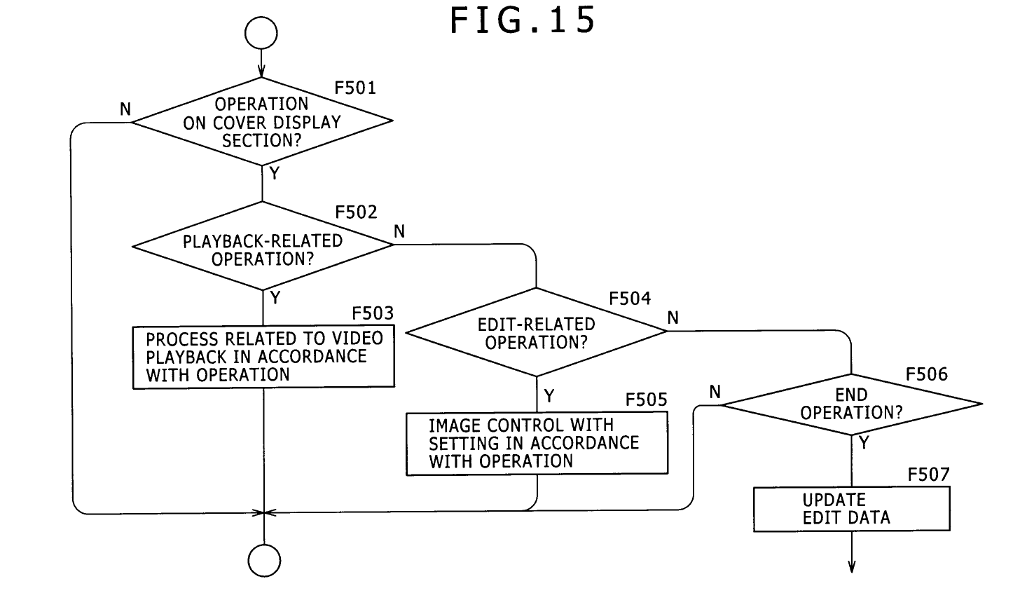

FIG. 15 illustrates a procedure performed by the system controller 20 when the edit screen as described above is being displayed.

If the system controller 20 detects any touch operation on the edit screen as illustrated in FIG. 18A, control proceeds from step F501 to step F502.

If the detected touch operation is an operation on one of the operation unit images 71 related to the video playback, control proceeds from step F502 to step F503, and the system controller 20 performs the video playback control in accordance with the detected touch operation.

For example, if the detected touch operation is pressing of the play button, the system controller 20 starts playback of the selected video clip. In this case, the system controller 20 causes the frame data of the clip to be read from the non-volatile memory section 22 sequentially to transfer them to the display data generation section 24. The display data generation section 24 performs a process of displaying the frame data sequentially as the clip image display 70 at an original frame rate of the clip, whereby the video clip is played back.

If the detected touch operation is the fast reverse or fast forward operation, the system controller 20 accordingly starts fast reverse playback or fast forward playback. In the case of the fast forward playback, for example, the system controller 20 causes a series of intermittent pieces of frame data to be read from the non-volatile memory section 22 sequentially, and causes the display data generation section 24 to display the series of intermittent pieces of frame data sequentially as the clip image display 70, whereby the fast forward playback is accomplished.

If the detected touch operation is the stop operation, the system controller 20 stops the playback, and allows a frame displayed at the time of the stop of the playback to continue to be displayed.

If the detected operation is an operation on any of the operation unit images 72 used for the editing work (except for the operation of ending the editing), control proceeds from step F504 to step F505, and the system controller 20 performs image control with a setting in accordance with the detected operation.

If the detected operation is an operation concerning the video level, for example, the system controller 20 holds a numerical value of the brightness level or the chroma level as specified by the detected operation, as an edit value, and also supplies the edit value of the brightness level or the chroma level to the display data generation section 24 to change the brightness level or the chroma level of the clip image display 70, i.e., the video being played back or a still image if the video playback is stopped.

Thus, the user is able to adjust the brightness level or the chroma level appropriately while viewing the clip image display 70.

If the detected operation is the image effect operation, the motion control operation, or the like, the system controller 20 holds an edit value in accordance with the detected operation, and also causes the edit value to be reflected in the clip image display 70.

If the detected operation is the user operation of ending the editing, control proceeds from step F506 to step F507, and the system controller 20 updates the edit data based on the held edit value(s), and finishes the editing process.

FIG. 18B illustrates an exemplary display on the cover display section 4 in which thumbnails of the edited clips are shown. This display is presented after the cut editing was performed using the sheets 7 or after the user performed an edit while viewing the video played back on the cover display section 4.

For example, the user may be allowed to perform a screen switching operation to switch from the edit screen as illustrated in FIG. 18A to this post-edit thumbnail display screen. Alternatively, after finishing the editing process as illustrated in FIG. 15, the system controller 20 may automatically switch the display on the cover display section 4 to the thumbnail display screen as illustrated in FIG. 18B.

The post-edit thumbnail display 60 clearly indicates the clips which have been edited one or more times. In the example of FIG. 18B, a character string “Edit” is displayed next to the clip name of each of the edited clips, and a frame is displayed that surrounds the thumbnail of each of the edited clips, to clearly indicate the edited clips to the user.

The editing process at step F3 as shown in FIG. 7 is performed in the above-described manner.

The user is still able to select any desired clip to perform the cut editing or the like thereon in a similar manner. For example, by selecting a clip that has not been edited yet using the thumbnail display 60 as illustrated in FIG. 18B, the user is able to cause the frames of the selected clip to be spread over the sheets 7, and then to edit the selected clip using the sheets 7 or the cover display section 4.

Needless to say, the user may be allowed to select any edited clip again to check the contents thereof or edit it again.

Further, it is possible to specify a plurality of in-points and out-points with respect to one clip.

If the user determines that he or she has completed necessary editing with respect to the downloaded clips, the user may upload the edit data at step F4 as shown in FIG. 7.

For example, while the edit book 1 is connected to the non-linear editor 100 as shown in FIG. 6 and the communication therebetween is possible, the user presses the operation button display 65, “Transmit All Edit Data,” or the operation button display 66, “Transmit Specified Edit Data.”

If the operation button display 65, “Transmit All Edit Data,” is pressed, the system controller 20 performs a process of uploading the edit data of each clip generated so far to the non-linear editor 100 collectively.

If the operation button display 66, “Transmit Specified Edit Data,” is pressed, the system controller 20 causes the cover display section 4 to present a display that is to be used for the user to specify a clip whose edit data is to be uploaded to the non-linear editor 100, for example, thereby prompting the user to specify such a clip. Then, in accordance with the specification by the user of such a clip, the system controller 20 performs a process of uploading the edit data of the specified clip to the non-linear editor 100.

The non-linear editor 100 stores the edit data transmitted from the edit book 1 in the storage section 102, and, treating the stored edit data as the edit data generated based on the operations on the non-linear editor 100 itself, causes the stored edit data to be reflected in the result of editing the video clips.

Thus, the series of editing work using the edit book 1 is completed.

### [7. Effects and Exemplary Variations of Embodiment]

The edit book 1 according to the above-described embodiment produces the following effects.

First, in connection with the downloaded video clip, the edit book 1 is capable of allowing the frames that constitute the video clip to be spread over the sheets 7 such that the frames are arranged on the pages in regular order along the time axis. Therefore, the user is able to check the contents of the clip with a feeling as if he or she were browsing a book. This makes it easier for the user, who is attempting to produce the video content, for example, to check the contents of the clip as the video materials. Moreover, unlike the case of checking the video contents using a dedicated machine for editing, such as the non-linear editor 100, which demands complicated operations, the user is able to check the video contents very easily with the edit book 1, which can be manipulated even by unskilled human editors.

The user is able to check the contents of the motion video with a feeling of turning pages, and thus to check the video while flipping through the pages very quickly. This manner of checking the video allows the user to feel as if he or she were viewing the video in motion, thus being a very suitable manner for checking the contents of the video and searching for the editing points.

In addition, the user is able to intuitively specify the in-point and the out-point using the sheets 7, by simply specifying any desired frames being displayed fixedly on the sheets. Thus, everyone can perform the cut editing easily, even without great skill.

Still further, not only the cut editing but also a variety of other editing operations is possible while viewing the video on the cover display section 4. This makes sophisticated editing tasks possible.

Each sheet 7 is formed by the electronic paper, and as noted previously, the electronic paper is capable of holding the image displayed thereon for a certain period of time (the length of the period depending on the type of the electronic paper; one week or so, for example) even after the power is turned off.

Therefore, once the frames of the clip are spread over the sheets 7, the user is able to check the frames using the sheets 7 even after the power is turned off. For example, the user may desire to avoid battery consumption because he or she is out of his or her home or traveling outdoors. Also, battery exhaustion may occur. Even in such cases, the user is able to check the frames while the power is off.

Since the frames are spread over the sheets 7, the user is able to place a bookmark or a note of an idea concerning editing, the video content, or the like at a portion of the video that interests the user, for example. For example, before actually specifying the in-point, the user is able to place bookmarks at several points that are candidates for the in-point. In such manners, the edit book 1 can be handled very intuitively.

Considering the possibility of the placement of the note and the like between the sheets 7, it is preferable that a coating be applied to surfaces of the sheets 7 so that graphite and ink may become less likely to be adhered to the surfaces of the sheets 7.

While the edit book 1 has been described above as one embodiment of the book-shaped display apparatus of the present invention, there are a great variety of conceivable variations and applications of the book-shaped display apparatus as the edit book 1.

The appearance, length, width, and thickness of the edit book 1, the structures of the cover portions 2 and 3, the sheets 7, and the spine portion 6, the number of sheets (i.e., the number of pages), the size of the cover display section 4, and the number of cover display sections 4 are not limited to those of the example as described above with reference to FIGS. 1, 2A, 2B, 3A, 3B, 4A, 4B, and 4C. Also note that the internal structure of the edit book is not limited to the structure as illustrated in FIG. 5.

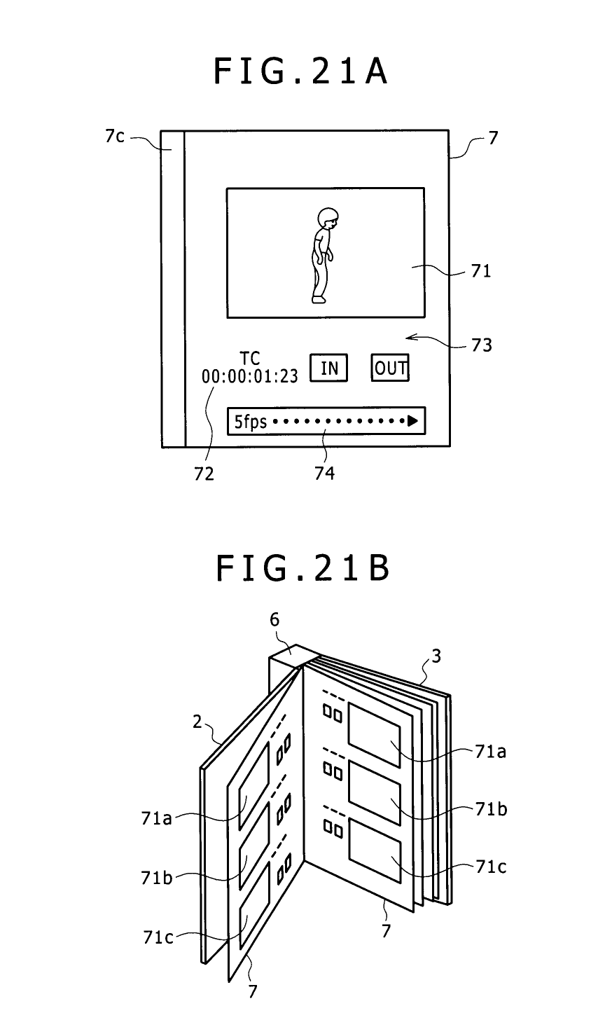

In the above-described embodiment, three frames are displayed on each of the sheets 7. Note, however, that as illustrated in FIG. 21A, one frame 71 and a time code 72, an operation button display 73, and an image 74 indicating fps for the frame 71 may be displayed on each sheet 7, for example.

Needless to say, four or more frames may be displayed on each sheet 7, depending on the size of the sheets 7.

Also note that as illustrated in FIG. 21B, both sides of each sheet 7 may be used as a display surface. When the frames are displayed on both sides of the sheets 7, the number of pages usable for displaying the frames is twice as many as the number of sheets.

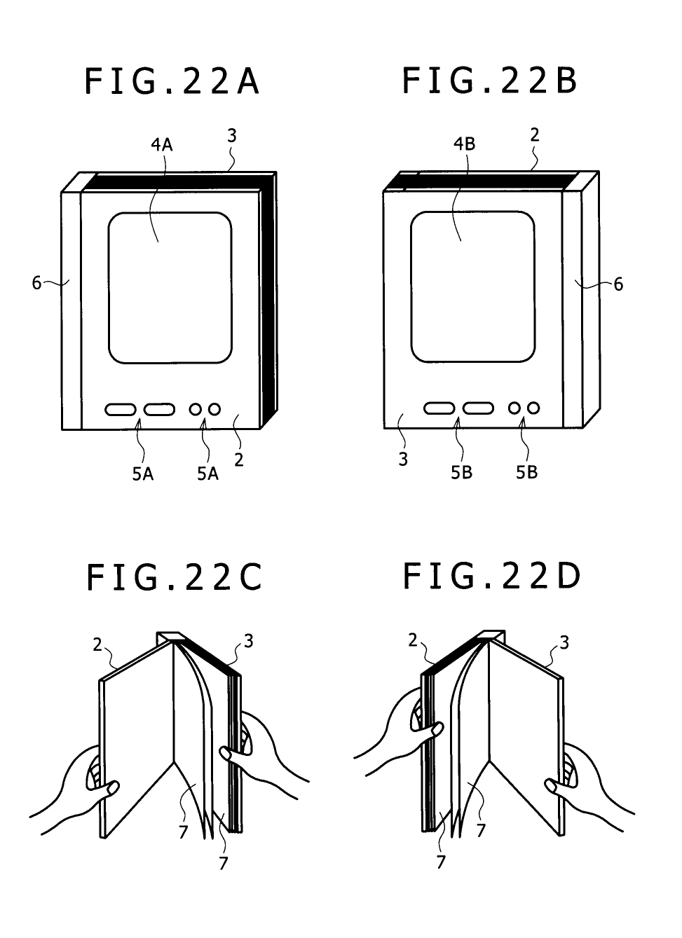

FIGS. 22A, 22B, 22C, and 22D illustrate an exemplary structure of the edit book in which a cover display section 4A and operation keys 5A, and a cover display section 4B and operation keys 5B, are provided on the cover portions 2 and 3, respectively. FIG. 22A shows a view of the edit book as seen from the side of the cover portion 2, while FIG. 22B shows a view of the edit book as seen from the side of the cover portion 3.

Regarding the sheets 7, for example, both sides of the sheets 7 are used as the display surfaces as in FIG. 21B described above.

This allows both right-handed people and left-handed people to use the edit book 1 in their own comfortable directions.

For example, the right-handed people will use the cover display section 4A and the operation keys 5A arranged on the cover portion 2. In this case, one side of each sheet 7, i.e., the side which the right-handed people can view more easily when flipping through the pages in a manner as illustrated in FIG. 22C, is used as the display surface, and the frames are spread over that side of each sheet 7.

On the other hand, the left-handed people will use the cover display section 4B and the operation keys 5B arranged on the cover portion 3. In this case, the opposite side of each sheet 7, i.e., the side which the left-handed people can view more easily when flipping through the pages in a manner as illustrated in FIG. 22D, is used as the display surface, and the frames are spread over that side of each sheet 7.

Thus, the edit book 1 with the above structure is convenient for both the right-handed and left-handed people.

In the above-described embodiment, it is assumed that the edit book 1 is connected to and communicates with the non-linear editor 100 via a cable according to a communication system such as USB or IEEE 1394. Note, however, that the edit book 1 may contain a communication unit for a wireless LAN, Bluetooth, optical communication, or the like and download data from and transfer the edit data to the non-linear editor 100 or the like in a wireless manner.

Also note that the edit book 1 may communicate with the non-linear editor 100 via a network such as the Internet. In this case, the user who owns the edit book 1 is able to communicate with the non-linear editor 100 located at a distance to download the clip therefrom or transmit the edit data thereto. For example, a human editor who is engaged in a broadcasting service is able to use the edit book 1 outside of a broadcasting station to access the non-linear editor 100 located in the broadcasting station to check the video materials or to perform an editing task.

Still further, the cover portion 2 or the cover display section 4 may be provided with a handwriting input section to accept a handwritten input, for example. In this case, the user enters characters as the handwritten input, and the system controller 20 converts the entered characters into text data, thus converting the entered characters into electronic information such as data of a note for the clip.

It has been assumed that the edit book 1 is used for the editing work. Note, however, that book-shaped display apparatuses according to other embodiments of the present invention may be used for other purposes than the video editing. For example, a book-shaped display apparatus according to one embodiment of the present invention may be used to download a motion video content and spread frames of the video content over the sheets 7, in order to introduce contents of the video content in the form of a comic book. This book-shaped display apparatus does not need to have an editing feature.

Also, a general user may download a motion video that has been filmed by himself or herself and stored in a personal computer or the like into the book-shaped display apparatus, and enjoy viewing the motion video as spread over the sheets in the form of a comic book.

That is, a book-shaped display apparatus according to one embodiment of the present invention is capable of providing a new way of entertainment that involves use of the video materials.

It should be understood by those skilled in the art that various modifications, combinations, sub-combinations and alterations may occur depending on design requirements and other factors insofar as they are within the scope of the appended claims or the equivalents thereof.

What is claimed is:

1. A book-shaped display apparatus, comprising:
a cover portion;
a plurality of sheet portions each formed by a flexible paper-like display device;
a spine portion that binds said cover portion and said plurality of sheet portions, so that the book-shaped display apparatus has a book-like structure with said sheet portions constituting pages;
an external interface section configured to receive, from an external device, pieces of frame data that constitute a video;
a storage section configured to store the pieces of frame data received via said external interface section;
a sheet display control section configured to drive each of said sheet portions to present a display; and
a control section configured to generate display image data for each of said sheet portions using the frame data stored in said storage section, supply the generated display image data to said sheet display control section, and control said sheet display control section to present a still image display on each of said sheet portions.

2. The book-shaped display apparatus according to claim 1, wherein said control section generates the display image data for each of said sheet portions such that the pieces of frame data that constitute the video progress continuously or intermittently along a time axis of the video with progress of the pages constituted by said sheet portions, and supplies the generated display image data to said sheet display control section.

3. The book-shaped display apparatus according to claim 2, wherein,
each of said sheet portions has provided thereon an operation input section used for an editing operation, and
said control section generates video edit data based on an operation performed using the operation input section.

4. The book-shaped display apparatus according to claim 3, wherein the operation input section is used for an operation of specifying a still image displayed on said sheet portion as an in-point or an out-point in the video.

5. The book-shaped display apparatus according to claim 3, wherein the operation input section is formed by a touch sensor provided on said sheet portion.

6. The book-shaped display apparatus according to claim 4, wherein,
each of said sheet portions is so configured that a sheet end face thereof is also capable of a display operation, and
if the operation of specifying the in-point or the out-point is performed on one of said sheet portions, said control section controls said sheet display control section to cause the sheet end face of said one of said sheet portions to perform the display operation.

7. The book-shaped display apparatus according to claim 3, wherein said control section performs a process of transmitting and outputting the video edit data to the external device via said external interface section.

8. The book-shaped display apparatus according to claim 1, wherein each of said sheet portions is formed by an electronic paper that maintains the display presented thereon even after power supply is stopped.

9. The book-shaped display apparatus according to claim 1, wherein said control section determines an interval between neighboring pieces of frame data that are read from said storage section and used to generate the display image data, based on the number of said sheet portions and the number of frames in one video unit represented by the pieces of frame data stored in said storage section.

10. The book-shaped display apparatus according to claim 1, wherein said control section determines an interval between neighboring pieces of frame data that are read from said storage section and used to generate the display image data, using motion information that represents the degree of motion in the video constituted by the pieces of frame data stored in said storage section.

11. The book-shaped display apparatus according to claim 1, wherein said cover portion has a display section formed thereon.

12. The book-shaped display apparatus according to claim 11, wherein,
said storage section stores one or more video units each constituted by a plurality of pieces of frame data, and
said control section causes an image representing each of the video units stored in said storage section to be displayed on the display section.

13. The book-shaped display apparatus according to claim 12, wherein,
said cover portion has an operation input section provided thereon, and
if one of the video units is selected by an operation performed using the operation input section, said control section generates the display image data using pieces of frame data that constitute the selected video unit stored in said storage section, supplies the generated display image data to said sheet display control section, and controls said sheet display control section to present the still image display on each of said sheet portions.

14. The book-shaped display apparatus according to claim 13, wherein the operation input section is formed by a touch sensor provided on the display section.

15. The book-shaped display apparatus according to claim 13, wherein, if one of the video units is selected by an operation performed using the operation input section, said control section controls the display section to present a display to be used for editing on the selected video unit.

16. The book-shaped display apparatus according to claim 13, wherein said control section generates video edit data in accordance with a video editing operation performed using the operation input section.

17. The book-shaped display apparatus according to claim 16, wherein said control section performs a process of transmitting and outputting the video edit data to the external device via said external interface section.

18. A method of editing a video using a book-shaped display apparatus including a cover portion, a plurality of sheet portions each formed by a flexible paper-like display device and having an operation input section used for an editing operation, and a spine portion that binds the cover portion and the sheet portions, so that the book-shaped display apparatus has a book-like structure with the sheet portions constituting pages, the method comprising the steps of:
inputting and storing pieces of frame data that constitute the video in the book-shaped display apparatus;
generating display image data for each of the sheet portions using the stored frame data, and presenting a still image display on each of the sheet portions using the generated display image data;
generating video edit data based on an operation performed using the operation input section; and
transmitting and outputting the video edit data generated in said generating of the video edit data to an external device.
